(19) United States
(12) Patent Application Publication
(10) Pub. No.: US 2026/0106783 A1
(43) Pub. Date: Apr. 16, 2026

(54) METHODS, APPARATUSES, AND DEVICES FOR COMMUNICATION IN INTEGRATED SENSING AND COMMUNICATION SYSTEMS

(71) Applicant: Huawei Technologies Co., Ltd., Shenzhen (CN)

(72) Inventors: Alireza Bayesteh, Brossard (CA); Shahram Shahsavari, Ottawa (CA); Jianglei Ma, Ottawa (CA); Wen Tong, Ottawa (CA)

(21) Appl. No.: 19/418,388

(22) Filed: Dec. 12, 2025

Related U.S. Application Data
(63) Continuation of application No. PCT/CN2023/099784, filed on Jun. 13, 2023.

(51) Int. Cl. H04L 27/12

(52) U.S. Cl. CPC H04L 27/12

(57) ABSTRACT

A method includes receiving configuration information pertaining to generating a sensing signal, the sensing signal being configured to convey information. The method also includes generating the sensing signal by selecting a subset of a plurality of linear frequency modulated (LFM) signals based on the configuration information, where the subset of the plurality of LFM signals are selected for the sensing signal from the plurality of LFM signals based on a mapping of a set of information bits. The set of information bits is used to convey the information in the sensing signal. The method also includes transmitting the sensing signal.

### CROSS-REFERENCE TO RELATED APPLICATION

The present application is a continuation of International Application No. PCT/CN2023/099784, entitled “METHODS, APPARATUSES, AND DEVICES FOR COMMUNICATION IN INTEGRATED SENSING AND COMMUNICATION SYSTEMS” and filed on Jun. 13, 2023, the entire contents of which are hereby incorporated by reference.

### TECHNICAL FIELD

The present disclosure relates generally to wireless communications, and in particular to methods, apparatuses, and devices for communication in integrated sensing and communication (ISAC) systems.

### BACKGROUND

Low power consumption and low operational complexity may be key factors in future wireless systems. It is anticipated that there will be many communication nodes with low power budgets and low computation capabilities in future networks. In such cases, radio frequency (RF) analog operations are generally preferred because digital processing increases both power consumption and complexity, especially at high frequencies. Sensing will also be an important service in future systems and a large number of low-capability and low power nodes will be involved in sensing. Sensing may be performed by a UE to obtain information about surroundings of the UE. Sensing allows the UE to detect information of one or more objects, such as, but not limited to, environment information in proximity to the UE, UE location, UE speed, UE orientation and with regard to objects in proximity to the UE, distance to an object and shape of the object. Sensing may involve the UE performing measurements of a signal, for example a sensing reference signal (SeRS) that is reflected off of an object. Measurements may be performed by radio-frequency (RF) sensing, e.g. a radio signal reflects off of an object and is measured by the UE. There are two types of sensing, mono-static sensing and bi-static sensing. For mono-static sensing, the transmitter and the receiver are the same device. For example, the UE sends a RF signal and receives an echo to measure and determine sensing results. For bi-static sensing, the transmitter and the receiver are different devices, e.g. the base station sends sensing signals and the UE receives the echo signals, or vice versa.

The combination of sensing and communication together is giving rise to so called integrated sensing and communication (ISAC) systems and networks. Future nodes in an ISAC network are expected be able to communicate information simultaneously as they are performing sensing. The information may be in the form of sensing side information, such as node identity (ID), node location, sensing attributes, sensing context and system information (SI).

### SUMMARY

Sensing waveforms capable of carrying information would benefit ISAC nodes. For example, a node acting as a receiver of such a sensing signal may obtain and/or decode the information using a simple sensing receiver structure. An example of a constraint for a sensing waveform is that the sensing performance should not be compromised. One such family of waveforms is linear frequency modulated (LFM) signal, an example of which may be a chirp signal, enabling low complexity RF-dominant detection. It would be beneficial to communication systems if a general ISAC framework existed for enabling the carrying of information on top of sensing waveforms that satisfies issues identified above.

There is a desirability in the subject matter described in this disclosure because it provides a framework which may be applied in a variety of sensing applications as explained below. Aspects of the disclosure provide a desirable solution because sensing is becoming an “of-interest” service for next generation wireless systems. There will likely be a large market for such a solution in 6G and future wireless systems since a majority of nodes or UEs of next generation wireless systems will likely implement universal sensing detection with a desirability for low complexity and low power consumption.

According to an aspect of the disclosure, there is provided a method including: receiving configuration information pertaining to generating a sensing signal, the sensing signal further configured to convey information; generating the sensing signal by selecting a subset of a plurality of linear frequency modulated (LFM) signals based on the configuration information, wherein the subset of the plurality of LFM signals are selected for the sensing signal from the plurality of LFM signals based on a mapping of a set of information bits to at least one of: selection of at least one LFM signal of the plurality of LFM signals; or modulation of at least one of the plurality of LFM signals; wherein the set of information bits is used to convey the information in the sensing signal; and transmitting the sensing signal.

In some embodiments, the configuration information includes an information mapping configuration information.

In some embodiments, the information mapping configuration includes only selection mapping or selection and modulation based mapping, wherein only selection mapping corresponds to selecting one or more parameters as part of the mapping of information on to the sensing signal and selection and modulation based mapping corresponds to selecting one or more parameters as part of the mapping as well as modulation of the sensing signal.

In some embodiments, the selection-only information mapping configuration is includes frequency shift-only mapping.

In some embodiments, the frequency shift-only mapping is a combination of sparsity pattern selection and frequency shift selection among the plurality of LFM signals.

In some embodiments, the information conveyed by the set of information bits is embedded in the sensing signal by embedding the information in at least one of: the frequency shift domain; the frequency shift domain and the modulation domain; or the frequency shift domain and the frequency slope domain.

In some embodiments, the plurality of LFM signals all have a same frequency slope.

In some embodiments, the starting frequency of an LFM signal of a given carrier index n in the plurality of LFM signals is expressed as fₙ=f₀+nΔf, n=0, . . . , N−1, wherein f₀ is a first frequency shift value; Δf is a LFM carrier spacing; and N is a total number of LFM carrier indices.

In some embodiments, the configuration information includes at least one of: a first frequency shift value f₀; a LFM carrier spacing Δf; a total number of LFM carrier indices N; or a maximum allowable number K* of LFM signals in the subset of the plurality of LFM signals.

In some embodiments, the information conveyed by the set of information bits includes at least one of: node identification; node location information; sensing type; sensing session identification; or system information (SI).

In some embodiments, the method further includes transmitting device capability information related to conveying information in the sensing signal.

According to an aspect of the disclosure, there is provided an apparatus including one or more processor configured to: receive configuration information pertaining to generating a sensing signal, the sensing signal configured to convey information; generate the sensing signal be selecting a subset of a plurality of LFM signals based on the configuration information, wherein the subset of the plurality of LFM signals are selected for the sensing signal from the plurality of LFM signals based on a mapping of a set of information bits to at least one of: selection of at least one LFM signal of the plurality of LFM signals; or modulation of at least one of the plurality of LFM signals; wherein the set of information bits is used to convey the information in the sensing signal; and transmit the sensing signal.

According to an aspect of the disclosure, there is provided an apparatus including a processor and a computer readable storage medium. The computer readable storage medium has stored thereon computer executable instructions that, when executed by the processor, that cause the apparatus to: receive configuration information pertaining to generating a sensing signal, the sensing signal configured to convey information; generate the sensing signal by selecting a subset of a plurality of LFM signals based on the configuration information, wherein the subset of the plurality of LFM signals are selected for the sensing signal from the plurality of LFM signals based on a mapping of a set of information bits to at least one of: selection of at least one LFM signal of the plurality of LFM signals; or modulation of at least one of the plurality of LFM signals; wherein the set of information bits is used to convey the information in the sensing signal; and transmit the sensing signal.

According to an aspect of the disclosure, there is provided a non-transitory computer readable storage medium, wherein the computer readable storage medium stores instructions that, when executed by a processor of an apparatus, enable the apparatus to perform a method as described above or detailed below.

According to an aspect of the disclosure, there is provided a method including: transmitting, by a network-side apparatus, configuration information pertaining to a device generating a sensing signal, the sensing signal configured to convey information by the device and the sensing signal including a subset of a plurality of LFM signals based on the configuration information, wherein the subset of the plurality of LFM signals are selected for the sensing signal from the plurality of LFM signals based on a mapping of a set of information bits to at least one of: selection of at least one LFM signal of the plurality of LFM signals; or modulation of at least one of the plurality of LFM signals; wherein the set of information bits is used to convey the information in the sensing signal.

In some embodiments, the configuration information includes an information mapping configuration information.

In some embodiments, the information mapping configuration includes only selection mapping or selection and modulation based mapping, wherein only selection mapping corresponds to selecting one or more parameters as part of the mapping of information on to the sensing signal and selection and modulation based mapping corresponds to selecting one or more parameters as part of the mapping as well as modulation of the sensing signal.

In some embodiments, the selection-only information mapping configuration includes frequency shift-only mapping.

In some embodiments, the frequency shift-only mapping is a combination of sparsity pattern selection and frequency shift selection among the plurality of LFM signals.

In some embodiments, the information conveyed by the set of information bits is embedded in the sensing signal by embedding the information in at least one of: the frequency shift domain; the frequency shift domain and the modulation domain; or the frequency shift domain and the frequency slope domain.

In some embodiments, the plurality of LFM signals all have a same frequency slope.

In some embodiments, the starting frequency of an LFM signal of a given carrier index n in the plurality of LFM signals is expressed as fₙ=f₀+nΔf, n=0, . . . , N−1, wherein f₀ is a first frequency shift value; Δf is a LFM carrier spacing; and N is a total number of LFM carrier indices.

In some embodiments, the configuration information includes at least one of: a first frequency shift value f₀; a LFM carrier spacing Δf; a total number of LFM carrier indices N; and a maximum allowable number K* of LFM signals in the subset of the plurality of LFM signals.

In some embodiments, the information conveyed by the set of information bits includes at least one of: node identification; node location information; sensing type; sensing session identification; or SI.

In some embodiments, the method further includes receiving device capability information related to a device conveying information in the sensing signal.

In some embodiments, the method further includes receiving the sensing signal.

According to an aspect of the disclosure, there is provided an apparatus including one or more processor configured to: transmit configuration information pertaining to generating a sensing signal, the sensing signal configured to convey information and the sensing signal including a subset of a plurality of LFM signals based on the configuration information, wherein the subset of the plurality of LFM signals are selected for the sensing signal from the plurality of LFM signals based on a mapping of a set of information bits to at least one of: selection of at least one LFM signal of the plurality of LFM signals; or modulation of at least one of the plurality of LFM signals; wherein the set of information bits is used to convey the information in the sensing signal.

According to an aspect of the disclosure, there is provided an apparatus including a processor and a computer readable storage medium. The computer readable storage medium has stored thereon computer executable instructions that, when executed by the processor, that cause the apparatus to: transmit configuration information pertaining to generating a sensing signal, the sensing signal configured to convey information and the sensing signal including a subset of a plurality of LFM signals based on the configuration information, wherein the subset of the plurality of LFM signals are selected for the sensing signal from the plurality of LFM signals based on a mapping of a set of information bits to at least one of: selection of at least one LFM signal of the plurality of LFM signals; or modulation of at least one of the plurality of LFM signals; wherein the set of information bits is used to convey the information in the sensing signal.

According to an aspect of the disclosure, there is provided a non-transitory computer readable storage medium, wherein the computer readable storage medium stores instructions that, when executed by a processor of an apparatus, enable the apparatus to perform a method as described above or detailed below.

### BRIEF DESCRIPTION OF THE DRAWINGS

For a more complete understanding of the present embodiments, and the advantages thereof, reference is now made, by way of example, to the following descriptions taken in conjunction with the accompanying drawings, in which:

FIG. 1A is a schematic diagram of a communication system in which embodiments of the present disclosure may occur.

FIG. 1B is another schematic diagram of a communication system in which embodiments of the present disclosure may occur.

FIG. 2 is a block diagram illustrating units or modules in a device in which embodiments of the present disclosure may occur.

FIG. 3 is a block diagram illustrating units or modules in a device in which embodiments of the present disclosure may occur.

FIG. 4 is an example of a LFM waveform.

FIG. 5A is an example of a frequency modulated continuous waveform (FMCW) LFM waveform.

FIG. 5B is an example of a triangular LFM waveform.

FIG. 6 illustrates an example configuration of an ISAC waveform matrix for several multiplexed BWPs in accordance with embodiments of the present disclosure.

FIG. 7 illustrates an example of a two dimensional (2D) ISAC waveform matrix S^{(k,l)} in accordance with embodiments of the present disclosure.

FIG. 8 shows an example of time and frequency plot for K possible chirp waveforms in accordance with embodiments of the present disclosure.

FIG. 9 illustrates an example of receiver structure used for receiving a sensing signal that has additional information embedded on the received signal in accordance with embodiments of the present disclosure.

FIG. 10 is a table including particular simulation assumptions in accordance with embodiments of the present disclosure.

FIG. 11 is a graphical plot resulting from simulation of four different signal types generated in accordance with embodiments of the present disclosure showing performance of Bit Error Rate versus signal-to-noise ratio.

FIG. 12 is an illustration of multiple LFM waveforms having the same LFM slope value and a common frequency shift between all LFM waveforms, where half of the LFM waveforms are used by a first UE as a sensing signal with embedded information and the other half of the LFM waveforms are used by a second UE as a sensing signal with embedded information.

FIGS. 13A and 13B are illustrations of multiple LFM waveforms that may be used by two different UEs for sensing signals with embedded information, the LFM waveforms having the same LFM slope value but a different number of frequency shifts and a different inter-frequency shift distance (Δf) between the LFM waveforms.

FIG. 14 illustrates an example of defining a communication channel using the proposed framework in accordance with embodiments of the present disclosure.

FIG. 15 illustrates an example of defining sensing channel using the proposed framework in accordance with embodiments of the present disclosure.

FIG. 16 is another example of a triangular LFM waveform.

FIG. 17 is network-side device-specific ISAC waveform configuration in accordance with embodiments of the present disclosure.

FIG. 18 is an example of a network-side ISAC code assignment over different BWPs in accordance with embodiments of the present disclosure.

FIG. 19 is a UE-specific ISAC waveform configuration in accordance with embodiments of the present disclosure.

FIG. 20 is an example of UE ISAC codebook assignment over different BWPs in accordance with embodiments of the present disclosure.

FIG. 21 include lookup tables for bit coding of frequency shift and LFM slope information embedding in accordance with embodiments of the present disclosure.

FIG. 22 is an example of joint data and signature embedding on the sensing signal.

FIG. 23 is a signal flow diagram for signaling between a UE and a base station (BS) illustrating an example method for configuring the UE to send a sensing signal with additional information embedded on the sensing signal, in accordance with embodiments of the present disclosure.

### DETAILED DESCRIPTION

For illustrative purposes, specific example embodiments will now be explained in greater detail below in conjunction with the figures.

The embodiments set forth herein represent information sufficient to practice the claimed subject matter and illustrate ways of practicing such subject matter. Upon reading the following description in light of the accompanying figures, those of skill in the art will understand the concepts of the claimed subject matter and will recognize applications of these concepts not particularly addressed herein. It should be understood that these concepts and applications fall within the scope of the disclosure and the accompanying claims.

Moreover, it will be appreciated that any module, component, or device disclosed herein that executes instructions may include or otherwise have access to a non-transitory computer/processor readable storage medium or media for storage of information, such as computer/processor readable instructions, data structures, program modules, and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e. DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Computer/processor readable/executable instructions to implement an application or module described herein may be stored or otherwise held by such non-transitory computer/processor readable storage media.

Aspects of the present disclosure provide apparatuses, devices, and methods for generating an ISAC waveform that may enable low-complexity RF-based sensing parameter detection. Aspects of the present disclosure provide apparatuses, devices, and methods for generating an ISAC waveform that may enable embedding digital (low rate) information in the sensing signal. Aspects of the present disclosure provide apparatuses, devices, and methods for generating an ISAC waveform that may enable low-complexity data decoding with acceptable performance.

Embodiments of the disclosure may be directed to a variety of scenarios in potential ISAC applications in which a sensing nodes may need to convey low-rate information simultaneously with the transmission of the sensing signal. Such low-rate information may include, but is not limited to, one or more of node ID, sensing type, and sensing session ID. Such scenarios cover many possible sensing applications such as pose estimation including positioning and synchronization. Pose refers to the sensing attributes of a UE including information related to position, velocity vector, heading and orientation. Sensing will be a provided service in future 6G systems. Aspects of this disclosure may apply to nodes functioning as a sensing transmitter and a sensing receiver.

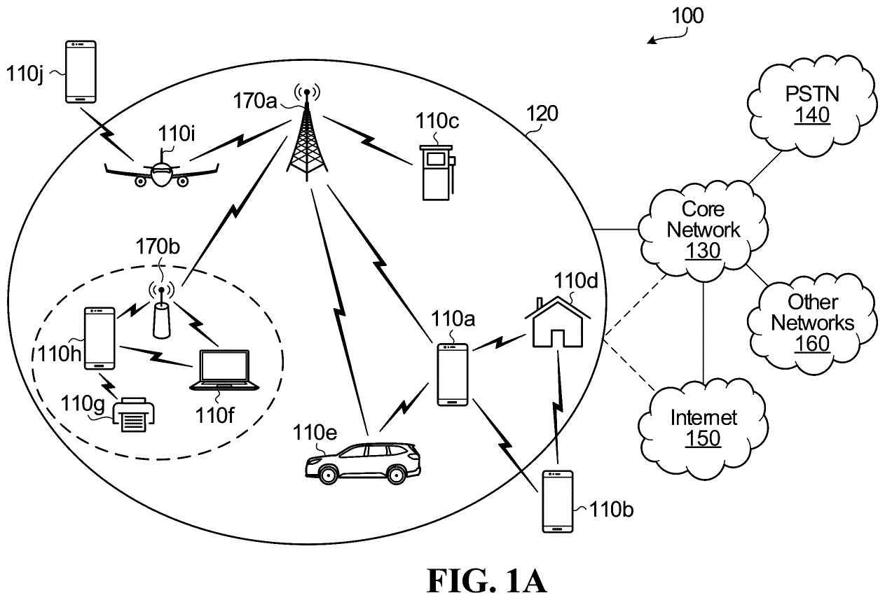

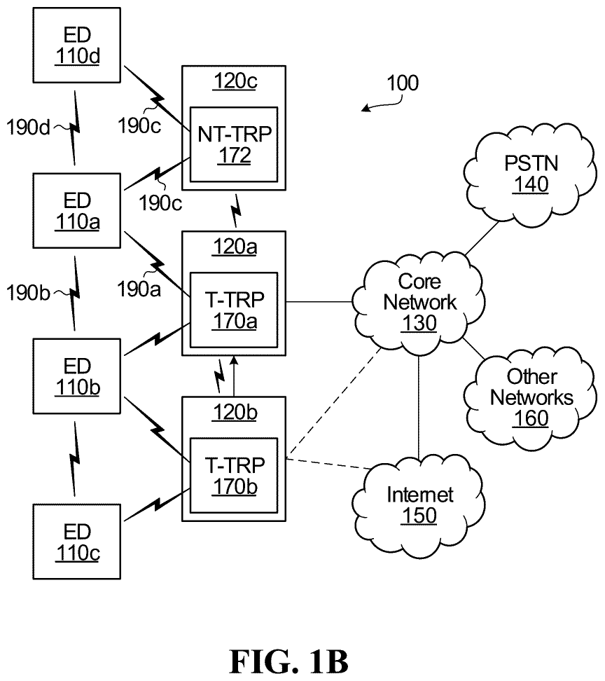

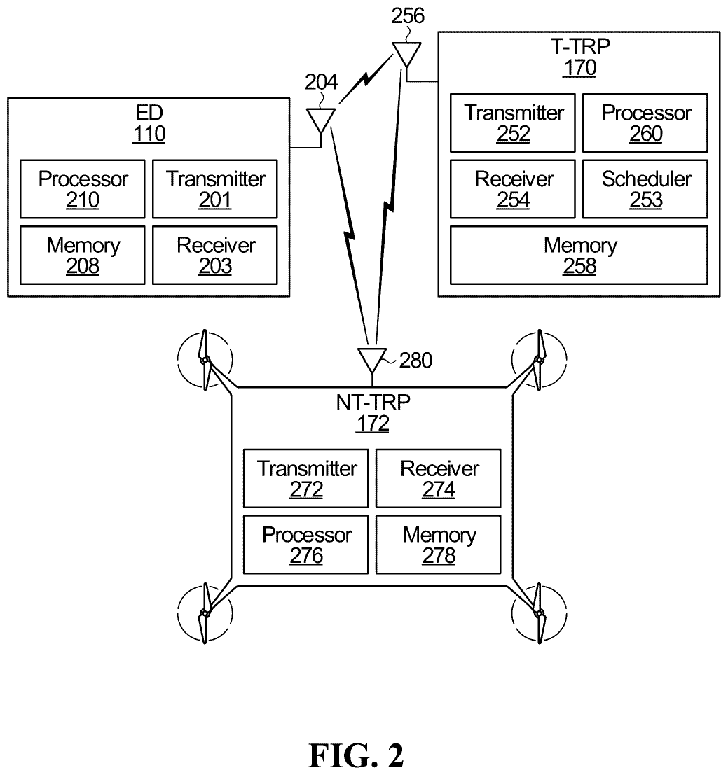

FIGS. 1A, 1B, and 2 following below provide context for the network and device that may be in the network and that may implement aspects of the present disclosure.

Referring to FIG. 1A, as an illustrative example without limitation, a simplified schematic illustration of a communication system is provided. The communication system 100 comprises a radio access network 120. The radio access network 120 may be a next generation (e.g. sixth generation (6G) or later) radio access network, or a legacy (e.g. 5G, 4G, 3G or 2G) radio access network. One or more communication electric device (ED) 110a-120j (generically referred to as 110) may be interconnected to one another, and may also or instead be connected to one or more network nodes (170a, 170b, generically referred to as 170) in the radio access network 120. A core network 130 may be a part of the communication system and may be dependent or independent of the radio access technology used in the communication system 100. Also the communication system 100 comprises a public switched telephone network (PSTN) 140, the internet 150, and other networks 160.

FIG. 1B illustrates an example communication system 100 in which embodiments of the present disclosure could be implemented. In general, the system 100 enables multiple wireless or wired elements to communicate data and other content. The purpose of the system 100 may be to provide content (voice, data, video, text) via broadcast, narrowcast, user device to user device, etc. The system 100 may operate efficiently by sharing resources such as bandwidth.

In this example, the communication system 100 includes electronic devices (ED) 110a-110c, radio access networks (RANs) 120a-120b, a core network 130, a public switched telephone network (PSTN) 140, the Internet 150, and other networks 160. While certain numbers of these components or elements are shown in FIG. 1B, any reasonable number of these components or elements may be included in the system 100.

The EDs 110a-110c are configured to operate, communicate, or both, in the system 100. For example, the EDs 110a-110c are configured to transmit, receive, or both via wireless communication channels. Each ED 110a-110c represents any suitable end user device for wireless operation and may include such devices (or may be referred to) as a user equipment/device (UE), wireless transmit/receive unit (WTRU), mobile station, mobile subscriber unit, cellular telephone, station (STA), machine type communication device (MTC), personal digital assistant (PDA), smartphone, laptop, computer, touchpad, wireless sensor, or consumer electronics device.

FIG. 1B illustrates an example communication system 100 in which embodiments of the present disclosure could be implemented. In general, the communication system 100 enables multiple wireless or wired elements to communicate data and other content. The purpose of the communication system 100 may be to provide content (voice, data, video, text) via broadcast, multicast, unicast, user device to user device, etc. The communication system 100 may operate by sharing resources such as bandwidth.

In this example, the communication system 100 includes electronic devices (ED) 110a-110d, radio access networks (RANs) 120a-120c, a core network 130, a public switched telephone network (PSTN) 140, the internet 150, and other networks 160. Although certain numbers of these components or elements are shown in FIG. 1B, any reasonable number of these components or elements may be included in the communication system 100.

The EDs 110a-110d are configured to operate, communicate, or both, in the communication system 100. For example, the EDs 110a-110d are configured to transmit, receive, or both, via wireless or wired communication channels. Each ED 110a-110d represents any suitable end user device for wireless operation and may include such devices (or may be referred to) as a user equipment/device (UE), wireless transmit/receive unit (WTRU), mobile station, fixed or mobile subscriber unit, cellular telephone, station (STA), machine type communication (MTC) device, personal digital assistant (PDA), smartphone, laptop, computer, tablet, wireless sensor, or consumer electronics device.

In FIG. 1B, the RANs 120a-120b include base stations 170a-170b, respectively. Each base station 170a-170b is configured to wirelessly interface with one or more of the EDs 110a-110c to enable access to any other base station 170a-170b, the core network 130, the PSTN 140, the internet 150, and/or the other networks 160. For example, the base stations 170a-170b may include (or be) one or more of several well-known devices, such as a base transceiver station (BTS), a Node-B (NodeB), an evolved NodeB (eNodeB), a Home eNodeB, a gNodeB, a transmission and receive point (TRP), a site controller, an access point (AP), or a wireless router.

In some examples, one or more of the base stations 170a-170b may be a terrestrial base station that is attached to the ground. For example, a terrestrial base station could be mounted on a building or tower. Alternatively, one or more of the base stations 172 may be a non-terrestrial base station, or non-terrestrial TRP (NT-TRP), that is not attached to the ground. A flying base station is an example of the non-terrestrial base station. A flying base station may be implemented using communication equipment supported or carried by a flying device. Non-limiting examples of flying devices include airborne platforms (such as a blimp or an airship, for example), balloons, quadcopters and other aerial vehicles. In some implementations, a flying base station may be supported or carried by an unmanned aerial system (UAS) or an unmanned aerial vehicle (UAV), such as a drone or a quadcopter. A flying base station may be a moveable or mobile base station that can be flexibly deployed in different locations to meet network demand. A satellite base station is another example of a non-terrestrial base station. A satellite base station may be implemented using communication equipment supported or carried by a satellite. A satellite base station may also be referred to as an orbiting base station.

Any ED 110a-110d may be alternatively or additionally configured to interface, access, or communicate with any other base station 170a-170b, the internet 150, the core network 130, the PSTN 140, the other networks 160, or any combination of the preceding.

The EDs 110a-110d and base stations 170a-170b, 172 are examples of communication equipment that can be configured to implement some or all of the operations and/or embodiments described herein. In the embodiment shown in FIG. 1B, the base station 170a forms part of the RAN 120a, which may include other base stations, base station controller(s) (BSC), radio network controller(s) (RNC), relay nodes, elements, and/or devices. Any base station 170a, 170b may be a single element, as shown, or multiple elements, distributed in the corresponding RAN, or otherwise. Also, the base station 170b forms part of the RAN 120b, which may include other base stations, elements, and/or devices. Each base station 170a-170b transmits and/or receives wireless signals within a particular geographic region or area, sometimes referred to as a “cell” or “coverage area”. A cell may be further divided into cell sectors, and a base station 170a-170b may, for example, employ multiple transceivers to provide service to multiple sectors. In some embodiments, there may be established pico or femto cells where the radio access technology supports such. In some embodiments, multiple transceivers could be used for each cell, for example using multiple-input multiple-output (MIMO) technology. The number of RAN 120a-120b shown is exemplary only. Any number of RAN may be contemplated when devising the communication system 100.

The base stations 170a-170b, 172 communicate with one or more of the EDs 110a-110c over one or more air interfaces 190a, 190c using wireless communication links e.g. radio frequency (RF), microwave, infrared (IR), etc. The air interfaces 190a, 190c may utilize any suitable radio access technology. For example, the communication system 100 may implement one or more orthogonal or non-orthogonal channel access methods, such as code division multiple access (CDMA), time division multiple access (TDMA), frequency division multiple access (FDMA), orthogonal FDMA (OFDMA), or single-carrier FDMA (SC-FDMA) in the air interfaces 190a, 190c.

A base station 170a-170b, 172 may implement Universal Mobile Telecommunication System (UMTS) Terrestrial Radio Access (UTRA) to establish an air interface 190a, 190c using wideband CDMA (WCDMA). In doing so, the base station 170a-170b. 172 may implement protocols such as High Speed Packet Access (HSPA), Evolved HPSA (HSPA+) optionally including High Speed Downlink Packet Access (HSDPA), High Speed Packet Uplink Access (HSPUA) or both. Alternatively, a base station 170a-170b, 172 may establish an air interface 190a,190c with Evolved UTMS Terrestrial Radio Access (E-UTRA) using LTE, LTE-A, and/or LTE-B. It is contemplated that the communication system 100 may use multiple channel access operation, including such schemes as described above. Other radio technologies for implementing air interfaces include IEEE 802.11, 802.15, 802.16, CDMA2000, CDMA2000 1×, CDMA2000 EV-DO, IS-2000, IS-95, IS-856, GSM, EDGE, and GERAN. Of course, other multiple access schemes and wireless protocols may be utilized.

The RANs 120a-120b are in communication with the core network 130 to provide the EDs 110a-110c with various services such as voice, data, and other services. The RANs 120a-120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a-120b or EDs 110a-110c or both, and (ii) other networks (such as the PSTN 140, the internet 150, and the other networks 160).

The EDs 110a-110d communicate with one another over one or more sidelink (SL) air interfaces 190b, 190d using wireless communication links e.g. radio frequency (RF), microwave, infrared (IR), etc. The SL air interfaces 190b, 190d may utilize any suitable radio access technology, and may be substantially similar to the air interfaces 190a, 190c over which the EDs 110a-110c communication with one or more of the base stations 170a-170b, or they may be substantially different. For example, the communication system 100 may implement one or more channel access methods, such as code division multiple access (CDMA), time division multiple access (TDMA), frequency division multiple access (FDMA), orthogonal FDMA (OFDMA), or single-carrier FDMA (SC-FDMA) in the SL air interfaces 190b, 190d. In some embodiments, the SL air interfaces 180 may be, at least in part, implemented over unlicensed spectrum.

In addition, some or all of the EDs 110a-110d may include operation for communicating with different wireless networks over different wireless links using different wireless technologies and/or protocols. Instead of wireless communication (or in addition thereto), the EDs may communicate via wired communication channels to a service provider or switch (not shown), and to the internet 150. PSTN 140 may include circuit switched telephone networks for providing plain old telephone service (POTS). Internet 150 may include a network of computers and subnets (intranets) or both, and incorporate protocols, such as internet protocol (IP), transmission control protocol (TCP) and user datagram protocol (UDP). EDs 110a-110d may be multimode devices capable of operation according to multiple radio access technologies, and incorporate multiple transceivers necessary to support multiple radio access technologies.

In some embodiments, the signal is transmitted from a terrestrial BS to the UE or transmitted from the UE directly to the terrestrial BS and in both cases the signal is not reflected by a RIS. However, the signal may be reflected by the obstacles and reflectors such as buildings, walls and furniture. In some embodiments, the signal is communicated between the UE and a non-terrestrial BS such as a satellite, a drone and a high altitude platform. In some embodiments, the signal is communicated between a relay and a UE or a relay and a BS or between two relays. In some embodiments, the signal is transmitted between two UEs. In some embodiments, one or multiple RIS are utilized to reflect the signal from a transmitter and a receiver, where any of the transmitter and receiver includes UEs, terrestrial or non-terrestrial BS, and relays.

FIG. 2 illustrates another example of an ED 110 and network devices, including a base station 170a, 170b (at 170) and an NT-TRP 172. The ED 110 is used to connect persons, objects, machines, etc. The ED 110 may be widely used in various scenarios, for example, cellular communications, device-to-device (D2D), vehicle to everything (V2X), peer-to-peer (P2P), machine-to-machine (M2M), machine-type communications (MTC), internet of things (IOT), virtual reality (VR), augmented reality (AR), industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to) as a user equipment/device (UE), a wireless transmit/receive unit (WTRU), a mobile station, a fixed or mobile subscriber unit, a cellular telephone, a station (STA), a machine type communication (MTC) device, a personal digital assistant (PDA), a smartphone, a laptop, a computer, a tablet, a wireless sensor, a consumer electronics device, a smart book, a vehicle, a car, a truck, a bus, a train, or an IoT device, an industrial device, or apparatus (e.g. communication module, modem, or chip) in the forgoing devices, among other possibilities. Future generation EDs 110 may be referred to using other terms. The base station 170a and 170b is a T-TRP and will hereafter be referred to as T-TRP 170. Also shown in FIG. 2, a NT-TRP will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

The ED 110 includes a transmitter 201 and a receiver 203 coupled to one or more antennas 204. Only one antenna 204 is illustrated. One, some, or all of the antennas may alternatively be panels. The transmitter 201 and the receiver 203 may be integrated, e.g. as a transceiver. The transceiver is configured to modulate data or other content for transmission by at least one antenna 204 or network interface controller (NIC). The transceiver is also configured to demodulate data or other content received by the at least one antenna 204. Each transceiver includes any suitable structure for generating signals for wireless or wired transmission and/or processing signals received wirelessly or by wire. Each antenna 204 includes any suitable structure for transmitting and/or receiving wireless or wired signals.

The ED 110 includes at least one memory 208. The memory 208 stores instructions and data used, generated, or collected by the ED 110. For example, the memory 208 could store software instructions or modules configured to implement some or all of the functionality and/or embodiments described herein and that are executed by the processing unit(s) 210. Each memory 208 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the internet 150 in FIG. 2). The input/output devices permit interaction with a user or other devices in the network. Each input/output device includes any suitable structure for providing information to or receiving information from a user, such as a speaker, microphone, keypad, keyboard, display, or touch screen, including network interface communications.

The ED 110 further includes a processor 210 for performing operations including those related to preparing a transmission for uplink transmission to the NT-TRP 172 and/or T-TRP 170, those related to processing downlink transmissions received from the NT-TRP 172 and/or T-TRP 170, and those related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Depending upon the embodiment, a downlink transmission may be received by the receiver 203, possibly using receive beamforming, and the processor 210 may extract signaling from the downlink transmission (e.g. by detecting and/or decoding the signaling). An example of signaling may be a reference signal transmitted by NT-TRP 172 and/or T-TRP 170. In some embodiments, the processor 210 implements the transmit beamforming and/or receive beamforming based on the indication of beam direction, e.g. beam angle information (BAI), received from T-TRP 170. In some embodiments, the processor 210 may perform operations relating to network access (e.g. initial access) and/or downlink synchronization, such as operations relating to detecting a synchronization sequence, decoding and obtaining the system information, etc. In some embodiments, the processor 210 may perform channel estimation, e.g. using a reference signal received from the NT-TRP 172 and/or T-TRP 170.

Although not illustrated, the processor 210 may form part of the transmitter 201 and/or receiver 203. Although not illustrated, the memory 208 may form part of the processor 210.

The processor 210, and the processing components of the transmitter 201 and receiver 203 may each be implemented by the same or different one or more processors that are configured to execute instructions stored in a memory (e.g. in memory 208). Alternatively, some or all of the processor 210, and the processing components of the transmitter 201 and receiver 203 may be implemented using dedicated circuitry, such as a programmed field-programmable gate array (FPGA), a graphical processing unit (GPU), or an application-specific integrated circuit (ASIC).

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), or a wireless router, a relay station, a remote radio head, a terrestrial node, a terrestrial network device, or a terrestrial base station, base band unit (BBU), remote radio unit (RRU), active antenna unit (AAU), remote radio head (RRH), central unit (CU), distributed unit (DU), positioning node, among other possibilities. The T-TRP 170 may be macro BSs, pico BSs, relay node, donor node, or the like, or combinations thereof. The T-TRP 170 may refer to the forging devices, or to apparatus (e.g. communication module, modem, or chip) in the forgoing devices. While the figures and accompanying description of example and embodiments of the disclosure generally use the terms AP, BS, and AP or BS, it is to be understood that such device could be any of the types described above.

In some embodiments, the parts of the T-TRP 170 may be distributed. For example, some of the modules of the T-TRP 170 may be located remote from the equipment housing the antennas of the T-TRP 170, and may be coupled to the equipment housing the antennas over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment housing the antennas of the T-TRP 170. The modules may also be coupled to other T-TRPs. In some embodiments, the T-TRP 170 may actually be a plurality of T-TRPs that are operating together to serve the ED 110, e.g. through coordinated multipoint transmissions.

The T-TRP 170 includes at least one transmitter 252 and at least one receiver 254 coupled to one or more antennas 256. Only one antenna 256 is illustrated. One, some, or all of the antennas may alternatively be panels. The transmitter 252 and the receiver 254 may be integrated as a transceiver. The T-TRP 170 further includes a processor 260 for performing operations including those related to: preparing a transmission for downlink transmission to the ED 110, processing an uplink transmission received from the ED 110, preparing a transmission for backhaul transmission to NT-TRP 172, and processing a transmission received over backhaul from the NT-TRP 172. Processing operations related to preparing a transmission for downlink or backhaul transmission may include operations such as encoding, modulating, precoding (e.g. multiple-input multiple-output (MIMO) precoding), transmit beamforming, and generating symbols for transmission. Processing operations related to processing received transmissions in the uplink or over backhaul may include operations such as receive beamforming, and demodulating and decoding received symbols. The processor 260 may also perform operations relating to network access (e.g. initial access) and/or downlink synchronization, such as generating the content of synchronization signal blocks (SSBs), generating the system information, etc. In some embodiments, the processor 260 also generates the indication of beam direction, e.g. BAI, which may be scheduled for transmission by scheduler 253. The processor 260 performs other network-side processing operations described herein, such as determining the location of the ED 110, determining where to deploy NT-TRP 172, etc. In some embodiments, the processor 260 may generate signaling, e.g. to configure one or more parameters of the ED 110 and/or one or more parameters of the NT-TRP 172. Any signaling generated by the processor 260 is sent by the transmitter 252. Note that “signaling”, as used herein, may alternatively be called control signaling. Dynamic signaling may be transmitted in a control channel, e.g. a physical downlink control channel (PDCCH), and static or semi-static higher layer signaling may be included in a packet transmitted in a data channel, e.g. in a physical downlink shared channel (PDSCH).

A scheduler 253 may be coupled to the processor 260. The scheduler 253 may be included within or operated separately from the T-TRP 170, which may schedule uplink, downlink, and/or backhaul transmissions, including issuing scheduling grants and/or configuring scheduling-free (“configured grant”) resources. The T-TRP 170 further includes a memory 258 for storing information and data. The memory 258 stores instructions and data used, generated, or collected by the T-TRP 170. For example, the memory 258 could store software instructions or modules configured to implement some or all of the functionality and/or embodiments described herein and that are executed by the processor 260.

Although not illustrated, the processor 260 may form part of the transmitter 252 and/or receiver 254. Also, although not illustrated, the processor 260 may implement the scheduler 253. Although not illustrated, the memory 258 may form part of the processor 260.

The processor 260, the scheduler 253, and the processing components of the transmitter 252 and receiver 254 may each be implemented by the same or different one or more processors that are configured to execute instructions stored in a memory, e.g. in memory 258. Alternatively, some or all of the processor 260, the scheduler 253, and the processing components of the transmitter 252 and receiver 254 may be implemented using dedicated circuitry, such as a FPGA, a GPU, or an ASIC.

Any or all of the EDs 110 and BS 170 may be sensing nodes in the system 100. Sensing nodes are network entities that perform sensing by transmitting and receiving sensing signals. Some sensing nodes are communication equipment that perform both communications and sensing. However, it is possible that some sensing nodes do not perform communications, and are instead dedicated to sensing. A sensing agent is an example of a sensing node that is dedicated to sensing. Unlike the EDs 110 and BS 170, the sensing agent does not transmit or receive communication signals. However, the sensing agent may communicate configuration information, sensing information, signaling information, or other information within the communication system 100. The sensing agent may be in communication with the core network 130 to communicate information with the rest of the communication system 100. By way of example, the sensing agent may determine the location of the ED 110a, and transmit this information to the base station 170a via the core network 130. Any number of sensing agents may be implemented in the communication system 100. In some embodiments, one or more sensing agents may be implemented at one or more of the RANS 120.

A sensing node may combine sensing-based techniques with reference signal-based techniques to enhance UE pose determination. This type of sensing node may also be known as a sensing management function (SMF). In some networks, the SMF may also be known as a location management function (LMF). The SMF may be implemented as a physically independent entity located at the core network 130 with connection to the multiple BSs 170. In other aspects of the present application, the SMF may be implemented as a logical entity co-located inside a BS 170 through logic carried out by the processor 260.

Although the NT-TRP 172 is illustrated as a drone only as an example, the NT-TRP 172 may be implemented in any suitable non-terrestrial form. Also, the NT-TRP 172 may be known by other names in some implementations, such as a non-terrestrial node, a non-terrestrial network device, or a non-terrestrial base station. The NT-TRP 172 includes a transmitter 272 and a receiver 274 coupled to one or more antennas 280. Only one antenna 280 is illustrated. One, some, or all of the antennas may alternatively be panels. The transmitter 272 and the receiver 274 may be integrated as a transceiver. The NT-TRP 172 further includes a processor 276 for performing operations including those related to: preparing a transmission for downlink transmission to the ED 110, processing an uplink transmission received from the ED 110, preparing a transmission for backhaul transmission to T-TRP 170, and processing a transmission received over backhaul from the T-TRP 170. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, and demodulating and decoding received symbols. In some embodiments, the processor 276 implements the transmit beamforming and/or receive beamforming based on beam direction information (e.g. BAI) received from T-TRP 170. In some embodiments, the processor 276 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The NT-TRP 172 further includes a memory 278 for storing information and data. Although not illustrated, the processor 276 may form part of the transmitter 272 and/or receiver 274. Although not illustrated, the memory 278 may form part of the processor 276.

The processor 276 and the processing components of the transmitter 272 and receiver 274 may each be implemented by the same or different one or more processors that are configured to execute instructions stored in a memory, e.g. in memory 278. Alternatively, some or all of the processor 276 and the processing components of the transmitter 272 and receiver 274 may be implemented using dedicated circuitry, such as a programmed FPGA, a GPU, or an ASIC. In some embodiments, the NT-TRP 172 may actually be a plurality of NT-TRPs that are operating together to serve the ED 110, e.g. through coordinated multipoint transmissions.

The T-TRP 170, the NT-TRP 172, and/or the ED 110 may include other components, but these have been omitted for the sake of clarity.

One or more steps of the embodiment methods provided herein may be performed by corresponding units or modules, according to FIG. 2. FIG. 2 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

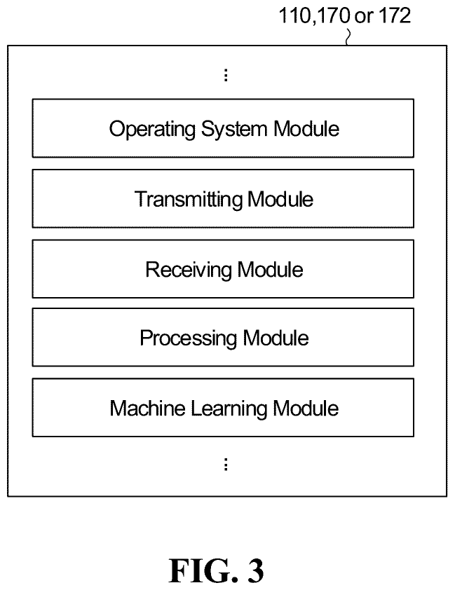

One or more steps of the embodiment methods provided herein may be performed by corresponding units or modules, according to FIG. 3. FIG. 3 illustrates units or modules in a device, such as in ED 110, in T-TRP 170, or in NT-TRP 172. For example, a signal may be transmitted by a transmitting unit or a transmitting module. A signal may be received by a receiving unit or a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be an integrated circuit, such as a programmed FPGA, a GPU, or an ASIC. It will be appreciated that where the modules are implemented using software for execution by a processor for example, they may be retrieved by a processor, in whole or part as needed, individually or together for processing, in single or multiple instances, and that the modules themselves may include instructions for further deployment and instantiation.

Additional details regarding the EDs 110, T-TRP 170, and NT-TRP 172 are known to those of skill in the art. As such, these details are omitted here.

Further terrestrial and non-terrestrial networks can enable a new range of services and applications such as earth monitoring, remote sensing, passive sensing and positioning, navigation, and tracking, autonomous delivery and mobility. Terrestrial networks based sensing and non-terrestrial networks based sensing could provide intelligent context-aware networks to enhance the UE experience. For example, terrestrial networks based sensing and non-terrestrial networks based sensing may involve opportunities for localization and sensing applications based on a new set of features and service capabilities. Applications such as THz imaging and spectroscopy have the potential to provide continuous, real-time physiological information via dynamic, non-invasive, contactless measurements for future digital health technologies. Simultaneous localization and mapping (SLAM) methods will not only enable advanced cross reality (XR) applications but also enhance the navigation of autonomous objects such as vehicles and drones. Further in terrestrial and non-terrestrial networks, the measured channel data and sensing and positioning data can be obtained by the large bandwidth, new spectrum, dense network and more light-of-sight (LOS) links. Based on these data, a radio environmental map can be drawn through AI/ML methods, where channel information is linked to its corresponding positioning or environmental information to provide an enhanced physical layer design based on this map.

Sensing coordinators are nodes in a network that can assist in the sensing operation. These nodes can be standalone nodes dedicated to just sensing operations or other nodes (for example TRP 170, ED 110, or core network node) doing the sensing operations in parallel with communication transmissions. A new protocol and signaling mechanism is needed so that the corresponding interface link can be performed with customized parameters to meet particular requirements while minimizing signaling overhead and maximizing the whole system spectrum efficiency.

AI/ML and sensing methods are data intensive. In order to involve AI/ML and sensing in wireless communications, more and more data are needed to be collected, stored, and exchanged. The characteristics of wireless data expand quite large ranges in multiple dimensions, e.g., from sub-6 GHz, millimeter to Terahertz carrier frequency, from space, outdoor to indoor scenario, and from text, voice to video. These data collecting, processing and usage operations are performed in a unified framework or a different framework.

Control information is referenced in some embodiments herein. Control information may sometimes instead be referred to as control signaling, or signaling. In some cases, control information may be dynamically communicated, e.g. in the physical layer in a control channel, such as in a physical uplink control channel (PUCCH) or physical uplink shared channel (PUSCH) or physical downlink control channel (PDCCH). An example of control information that is dynamically indicated is information sent in physical layer control signaling, e.g., uplink control information (UCI) sent in a PUCCH or PUSCH or downlink control information (DCI) sent in a PDCCH. A dynamic indication may be an indication in a lower layer, e.g., physical layer/layer 1 signaling, rather than in a higher-layer (e.g. rather than in RRC signaling or in a MAC CE). A semi-static indication may be an indication in semi-static signaling. Semi-static signaling, as used herein, may refer to signaling that is not dynamic, e.g. higher-layer signaling (such as RRC signaling), and/or a MAC CE. Dynamic signaling, as used herein, may refer to signaling that is dynamic, e.g., physical layer control signaling sent in the physical layer, such as DCI sent in a PDCCH or UCI sent in a PUCCH or PUSCH.

A common disadvantage of existing solutions may be summarized as the existing solutions are not capable of embedding digital data in the sensing signal without compromising the sensing performance and/or receiver complexity, so they are not as suitable for low-power and low complexity joint sensing and communication in future ISAC networks.

In some embodiments, in order to address problems discussed above, methods are proposed for generating an ISAC waveform that includes selecting a plurality of LFM waveforms as the basis for the entire waveform space, in the double domain of pseudo-Doppler pre-shift (frequency) and LFM slope (α). Doppler is a frequency shift in a transmitted waveform. An “intentional” frequency shift in the transmitted signal may be interpreted as a pseudo-Doppler frequency, which may be treated as Doppler frequency when detecting at the receiver.

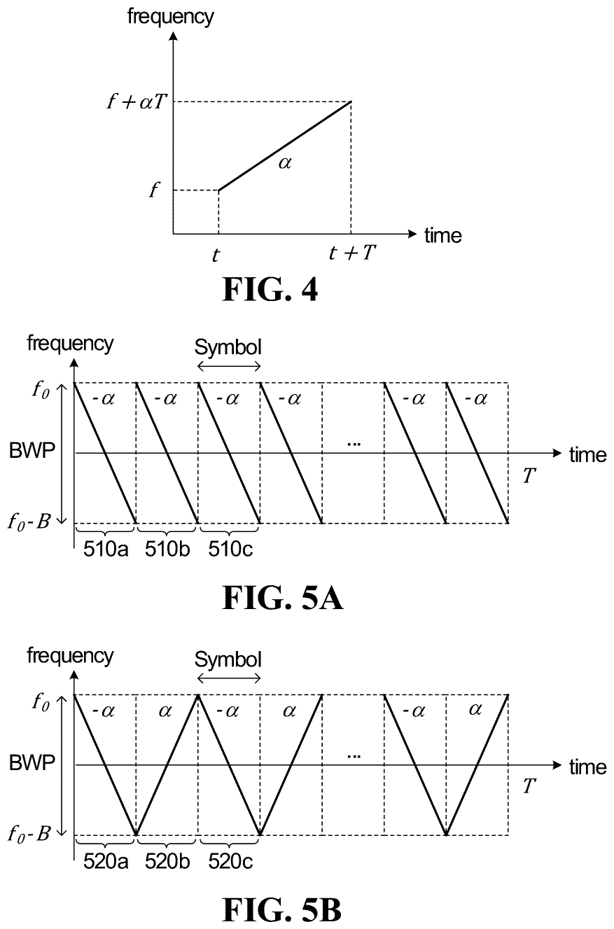

Another name commonly used for LFM waveform is a chirp waveform. An LFM or chirp waveform is a waveform whose frequency is a linear function of time having a slope that is called chirp rate or LFM rate. FIG. 4 illustrates a chirp waveform representation in the time-frequency domain. Time is represented along the horizontal axis and frequency is along the vertical axis. A starting time and frequency of the waveform are indicated by parameters t and f, respectively, in FIG. 4. The chirp rate is indicated by parameter α and the time duration of the chirp waveform by parameter T. Therefore, the endpoint of the chirp waveform may be determined as t+T in the time domain and f+αT in the frequency domain, as shown in FIG. 4.

A chirp-based signal may be defined as a signal based on single chirp waveform shown in the example of FIG. 4. Two examples of chirp-based signals are shown in FIG. 5A and FIG. 5B. The first example shown in FIG. 5A is a frequency modulated continuous waveform (FMCW) signal that comprises multiple single chirps multiplexed in the time domain. Each chirp has a chirp rate of the same slope −α. The bandwidth of the frequency is equal to B and a starting frequency for the chirp is f₀, result in an ending frequency of f₀-B. The second example shown in FIG. 5B is a triangular waveform that is constructed of multiple single chirp waveforms with alternating sign chirp rates, −α, α. In FIGS. 5A and 5B each chirp occurs over a given time duration 510a, 510b, 510c in FIG. 5A or 520a, 520b, 520c in FIG. 5B, which may be referred to as “sensing symbol”.

In some embodiments, digital information may be embedded in the selection of the plurality of LFM waveforms and/or modulation of each selected waveform. In some embodiments, embedding the digital information in this manner may preserve low-complexity RF-domain detection. In some embodiments, embedding the digital information in this manner may not compromise the sensing performance.

In some embodiments, an ISAC waveform may be represented as a 4-dimensional (4D) matrix. Two dimensions of the 4D matrix may represent frequency and time components (e.g., a sub-band or a bandwidth part (BWP), and time symbol indices, respectively) of the sensing signal. Referring to FIGS. 5A and 5B, a sub-band or BWP may correspond to the f₀-B bandwidth of a particular chirp and there are multiple such chirps having similar bandwidths over a large frequency band. Furthermore, the time symbol indices may correspond to symbols shown in FIGS. 5A and 5B. A third dimension of the 4D matrix may represent a list of potential linear slope or chirp slope vectors (α₁, . . . , α_{M}). For example, while FIGS. 5A and 5B show a single slope, be that-a or a, different chirps in different sub-bands or BWPs may have different slopes. A fourth dimension of the 4D matrix may represent a list of potential initial frequency selection vectors (f₁, . . . , f_{N}), where the initial frequency refers to the start frequency of a chirp or LFM waveform. Alternatively, the initial frequency may be referred to as a frequency shift.

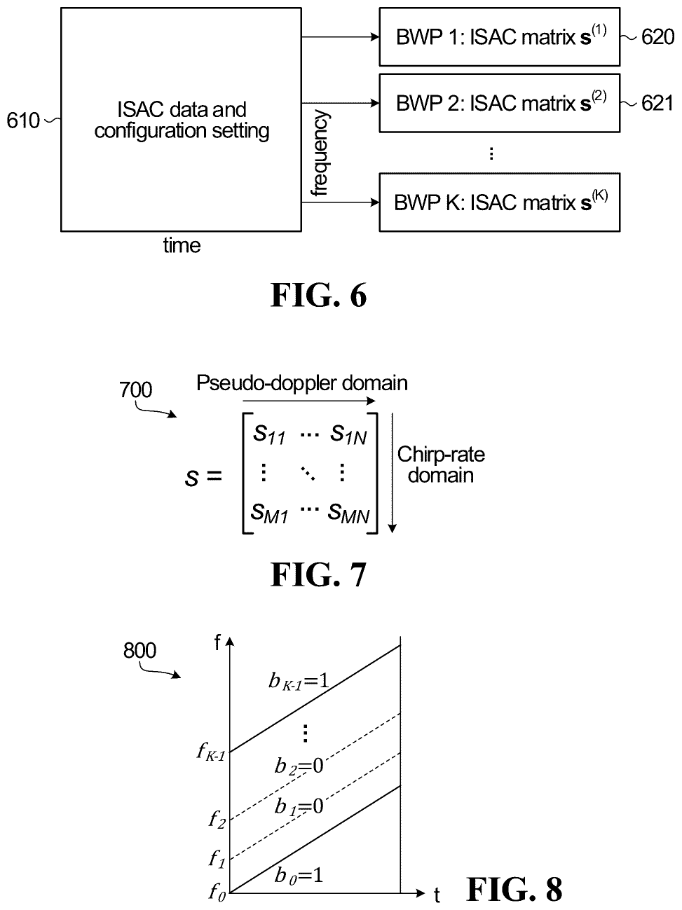

For each kth sub-band or BWP and lth symbol a set of chirp waveforms, where k and l are integers, an ISAC waveform may be expressed as a 2D matrix (denoted by S^{(k,l)}), wherein an element (i, n) specifies data to be transmitted over an ith chirp and nth frequency element, where i and n are integers. An example of how ISAC data and configuration setting 610 information may be used to determine multiple 2D ISAC matrices 620,621, one matrix for each BWP, is shown in FIG. 6. The ISAC data and configuration setting 610 information enables ISAC matrices for each sub-band or BWP in the signal. An example of the 2D ISAC matrix S^{(k,l)} 700 is shown in FIG. 7. The 2D ISAC matrix 700 shows N columns of initial frequency or frequency shift matrix elements in the pseudo-doppler domain and M rows of LFM rate matrix elements in the LFM rate (i.e., slope) domain.

In some embodiments, the frequency shift values may be expressed as fₙ=f₀+nΔf wherein f₀ is a first frequency shift value and Δf is a chirp carrier spacing. The chirp carrier spacing is the distance between two adjacent LFM signals (chirps).

A waveform for transmission over the kth sub-band or BWP and the lth sensing symbol may be expressed as:

$${x}^{( k , l )} ( t ) = \frac{1}{\sqrt{{\sum }_{i = 0}^{M - 1} {\sum }_{n = 0}^{N - 1} {I}_{i , n}^{( k , l )} {\vert {q}_{i , n}^{( k , l )} \vert}^{2}}} {\sum }_{i = 0}^{M - 1} {\sum }_{n = 0}^{N - 1} {S}_{i , n}^{( k , l )} {C}_{i , n}^{( k , l )} ( t )$$

$$where in {C}_{i ,}^{( k , l )} ( t ) is the LFM index ( i , n ) .$$

In the case of a FMCW waveform, the waveform may be expressed as:

$${C}_{i , n}^{( k , l )} ( t ) = {e}^{j 2 π ( {f}_{0}^{( k , l )} + nΔf - Z ( t ) B ) ( t - l T ) + j π {{α}_{i}^{( k , l )} ( t - l T )}^{2}} Π ( \frac{t - l T}{{γ}_{i , l} T} ) .$$

In the case of triangular chirp waveform, the waveform may be expressed as:

$${C}_{i , n}^{( k , l )} ( t ) = {e}^{j 2 π ( {f}_{0}^{( k , l )} + n Δ f - Z ( t ) B ) ( t - l T ) + {{j π α}_{i}^{( k , l )} ( t - l T )}^{2}} Π ( \frac{t - lT}{{ℽ}_{i , l} T} ) + {e}^{j 2 ( {f}_{0}^{( k , l )} + n △ f + {ℽ}_{i , l} {α}_{i}^{( k , l )} T ) ( t - ( l + {ℽ}_{i , l} ) T ) - {{j β}_{i}^{( k , l )} ( t - ( l + {ℽ}_{i , l} ) T )}^{2}} Π ( \frac{t - ( l + {ℽ}_{i , l} ) T}{( 1 - {ℽ}_{i , l} ) T} ) .$$

In some embodiments,

$${C}_{i , n}^{( k , l )} ( t )$$

may be expressed as the following formula, which includes both FMCW and triangular LFM waveforms:

$${C}_{i , n}^{( k , l )} ( t ) = {e}^{j 2 π ( {f}_{0}^{( k , l )} + n Δ f - Z ( t ) B ) ( t - l T )} [ {s}_{{α}_{i}^{( k , l )}} ( t - lT ) Π ( \frac{t - lT}{{ℽ}_{i , l} T} ) + ( 1 - {ϑ}^{( k , l )} ) {e}^{j 2 π ( {f}_{0}^{( k , l )} + n Δ f + {γ}_{i , l} {α}_{i}^{( k , l )} T ) ( t - ( l + {γ}_{i , l} ) T )} {s}_{- {β}_{i}^{( k , l )}} ( t - ( l + {γ}_{i , l} ) T ) Π ( \frac{t - ( l + {γ}_{i , l} ) T}{( 1 - {γ}_{i , l} ) T} ) ]$$

$$wherein Π ( \frac{t}{T} ) = \{ \begin{matrix}1 & 0 \leq t \leq T \\ 0 & otherwise\end{matrix} and {s}_{α} ( t ) = exp ( {j πα t}^{2} ) .$$

The parameter B is LFM bandwidth, which may be selected from a given set of bandwidths Ω={B₁, B₂, . . . , B_{N}} expressed in frequency units, for example, but not limited to, MHz, wherein the set Ω is given by the field SeRSBandwidth contained in the higher layer parameter SensingResourceMapping. In some embodiments, the LFM bandwidth B may be expressed as a multiple of a communication resource block group (RBG) size, for example, B=η₁B_{RBG} for some integer η₁. In some embodiments, the LFM bandwidth B may be expressed as a multiple of a communication resource block (RB) size, for example, B=η₂B_{RB} for some integer η₂. In some embodiments, the LFM bandwidth B may be expressed as a multiple of a communication subcarrier spacing, for example, B=η₃SCS for some integer η₃.

The LFM time duration T∈Φ={T₁, T₂, . . . , T_{M}} may be expressed in terms of time units such as milliseconds (ms) or microseconds (μs). In some embodiments, the set ¢ may be defined by an information field in higher layer signaling. For example, the information field may be named SeRSSymbolTime and the higher layer signaling may be part of a parameter such as SensingResourceMapping.

In some embodiments, the LFM time duration T=μT_{com} may be expressed as a multiple of communication symbol duration, wherein T_{com} denotes symbol time duration including cyclic prefix orthogonal frequency divisional multiplexing (CP-OFDM), discrete Fourier transform orthogonal frequency divisional multiplexing (DFT-OFDM) or other waveform, and μ is a configuration parameter that may be an integer value or a fraction. In some embodiments, the integer value may be expressed as 2ⁿ^{₁} for some integer value n₁ and the fraction value may be expressed as 2⁻ⁿ^{₂} for some integer n₂.

The parameter ϑ^{(k,l)} is a higher layer parameter indicating a type of waveform, and may, for example, be identified as WaveformTypeIndicator, in the Sensing Reference Signal (SeRS) resource. The value of ϑ^{(k,l)} may be set to 1 for a FMCW waveform and 0 for a triangular waveform. In the case that ϑ^{(k,l)}=1, γ_{i,l} may be set to 1 and in the case that ϑ^{(k,l)}=0, γ_{i,l} may be obtained from

$${ℽ}_{i , l} = \frac{B}{{α}_{i , l} T} .$$

The parameter

$${f}_{0}^{( k , l )}$$

is a first frequency shift value of the LFM signal over the BWP k. In some embodiments,

$${f}_{0}^{( k , l )}$$

may be expressed as a vector (such as for RBG index, RB index, resource element (RE) index) corresponding to communication numerology. In some embodiments, the frequency shift value

$${f}_{0}^{( k , l )}$$

may be expressed as:

$${f}_{0}^{( k , l )} = ( B - N Δ {f}^{( k , l )} ) \frac{{n}_{I D}^{S e R S} mod ( ⌈ B / Δ {f}^{( k , l )} ⌉ - N )}{⌈ B / Δ {f}^{( k , l )} ⌉ - N}$$

wherein

$${n}_{I D}^{SeRS}$$

denotes the SeRS signature ID. In some embodiments,

$${f}_{0}^{( k , l )}$$

may be set to a fixed value, e.g. 0. In some embodiments,

$${f}_{0}^{( k , l )}$$

may be obtained based on the analog sensing information in a manner consistent with the subject matter described in Applicant's co-pending patent application PCT/CN2023/094933 filed on May 18, 2023. In some embodiments,

$${f}_{0}^{( k , l )}$$

may be a relative location to a frequency reference point such as SSB or any other pre-defined reference signal point in terms of number of RB, number of RE, etc.

The parameter Δf^{(k,l)} denotes the frequency shift unit between adjacent LFM signals for the kth BWP and lth sensing symbol. In some embodiments, the parameter Δf^{(k,l)} may be expressed as a multiple of the communication subcarrier spacing. In some embodiments, the parameter Δf^{(k,l)} may be configured per BWP and per sensing symbol for each UE or it may be configured as a single parameter to be used across all BWPs and symbols. In some embodiments, the parameter Δf^{(k,l)} may be expressed as a portion of the bandwidth, i.e. Δf^{(k,l)}=B/Q for some integer Q.

The parameter

$${α}_{i}^{( k , l )}$$

is the LFM rate, which may also be referred to as the LFM slope, which may be obtained by:

$${α}_{i}^{( k , l )} = \frac{B}{T} f ( i )$$

The parameter f(i) is a linear function which may be expressed as

$$1 + \frac{i {K}_{1}}{{K}_{2}}$$

for some integer values K₁ and K₂. Also, in the case of ϑ^{(k,l)}=0 (triangular waveform),

$${β}_{i}^{( k , l )} = \frac{B {α}_{i}^{( k , l )}}{T {α}_{i}^{( k , l )} - B} .$$

In some embodiments, where the data embedding is not in the LFM rate domain, f(i) may be a fixed value c leading to

$${α}_{i}^{( k , l )} = c B / T .$$

In some embodiments, c=1 leads to

$${α}_{i}^{( k , l )} = B / T .$$

In some embodiments,

$${α}_{i}^{( k , l )} = \frac{B}{T} f ( i )$$

may be obtained based on the mapping function between

$${n}_{I D}^{SeRS}$$

and i. For example,

$${α}_{i}^{( k , l )} = 1 + \frac{i {K}_{1}}{{K}_{2}} ,$$

wherein i may be obtained from

$$i = {n}_{ID}^{SeRS} mod {K}_{2} .$$

The integer Z(t) is defined such that the quantity

$${f}_{0}^{( k , l )} + n Δ f - Z ( t ) B + {α}_{i}^{( k , l )} t$$

is between 0 and B at any time t.

The (i, n)th element of matrix S^{(k,l)} may be expressed as

$${S}_{i , n}^{( k , l )} = {I}_{i , n}^{( k , l )} {q}_{i , n}^{( k , l )} where {I}_{i , n}^{( k , l )}$$

denotes the LFM signal p index selection indicator, which is equal to 1 if a specific LFM signal is selected and 0 if that specific LFM signal is not selected, and

$${q}_{i , n}^{( k , l )}$$

denotes the QAM symbol to be transmitted over the LFM signal index of (i, n).

In general, information embedded in the sensing signal may be expressed as b={b_{I}, b_{q}}. The set of bits b_{I} is a set of bits mapped to the LFM signal index selection indicator 4-D matrix I, which is defined as

$$\{ {I}_{i , n}^{( k , l )} \}$$

over the dimensions of frequency shift index, LFM signal rate index, BWP index and symbol index. The set of bits b_{q} is a set of bits mapped to QAM symbols used to modulate the selected LFM signals. In some embodiments, the information is only embedded in the LFM signal index domain, i.e. b={b_{I}}, i.e. there is no b_{q} component. The set of bits b_{I} may further be decomposed into b_{I}={b_{fs}, b_{α}}, which includes sets of bits b_{fs} corresponding to information embedded in the frequency shift domain and sets of bits b_{α} corresponding to information embedded in the LFM signal rate domain. In some embodiments, the manner in which information is embedded over the domains of frequency shift and LFM signal rate may vary from BWP to BWP (as a function of frequency hopping) or from symbol to symbol (as a function of time slot hopping). In some embodiments, the set of bits b may be the set of information bits. This may occur in a case where embedding includes additional no forward error correction (FEC), such as in the case of embedding coded bits obtained from an upstream FEC.

Configuration information for embedding sets of information bits may be signaled to the sending nodes using layer 1 (i.e., PHY) signaling or higher layer signaling, such as radio resource control (RRC) signaling. In some embodiments, the configuration information may be the same for all allocated or configured BWPs and symbols for a sensing node. In such cases, only one configuration information message may be sent and the sensing node may apply the configuration information to all configured BWPs/symbols. In some embodiments, the configuration information may be different for at least two allocated or configured BWPs and symbols for a sensing node. If the configuration information is different across different configured BWPs/symbols, then configuration information that is common to some of the allocated or configured BWPs and symbols may be sent to the sensing node in addition to BWP or symbol-specific configuration information.

For a particular BWP #k and symbol #l, and denoting the 2D LFM signal index selection indicator matrix for the BWP/symbol indices (k,l) by I^{(k,l)}, the 2D LFM signal index selection indicator matrix may be expressed as

$${I}^{( k , l )} = {I}_{fs}^{{( k , l )}^{T}} \cdot {I}_{α}^{( k , l )} ,$$

wherein

$${I}_{fs}^{( k , l )}$$

denotes a frequency shift index vector for given information bits b_{fs} and

$${I}_{α}^{( k , l )}$$

denotes a LFM signal rate index vector for given information bits b_{α}. When there is no information embedded in the frequency shift domain, the frequency shift may have a fixed value, such as f*, and

$${I}_{fs}^{( k , l )}$$

may be expressed as [0 . . . 1 0 . . . 0], wherein each bit equal to “1’ corresponds to f*. The same thing may apply to

$${I}_{α}^{( k , l )} .$$

In some embodiments, there are multiple different modes of information embedding, which are explained in the next sections.

In some embodiments, a first mode may include no information embedding. Such a mode may be used as a mode if there is no information to be embedded or if the sensing device is no capable of embedding information. In some embodiments, a second mode may include information embedding only on the frequency shift domain

$${I}_{fs}^{( k , l )} .$$

In some embodiments, a third mode may include information embedding on the frequency shift domain and modulation domain (e.g. QAM). In some embodiments, a fourth mode may include information embedding on the frequency shift domain and LFM signal rate domain.

Signaling of configuration information may be performed depending on which mode of information embedding is to be used. Further details will be provided below with a particular focus on the mode for embedding only on the frequency shift domain

$${I}_{fs}^{( k , l )} .$$

Further details will be provided below showing how a proposed framework may be used to provide multiplexing between sensing and communication signals. Further details will also be provided below pertaining to how information, such as UE ID, or more generally a signature ID, may be mapped to LFM parameters on top of other information to be embedded.

An example will now be described for which information is embedded only in the frequency shift (FS) domain, i.e. information embedding only on

$${I}_{fs }^{( k , l )} ,$$

assuming the potential number of frequency shift (FS) values to be K. FIG. 8 shows an example of a time and frequency plot 800 for K possible LFM signal waveforms. Each LFM signal waveform has a corresponding single value, indicated as b₀ to b_{K-1}. FIG. 8 illustrates a particular example where each of the bits corresponds to either a 1 or 0 depending on whether the LFM signal is to be used or not to embed further information in the sensing signal. In particular, bits b₀ and b_{K-1}, are both shown to be equal to 1, meaning these LFM waveforms are used to embed information in the sensing signal and bits b₁ and b₂ are shown to be equal to 0, meaning these LFM waveforms are used to embed information in the sensing signal. The information bit mapping from

$${b}_{fs} \to {I}_{fs}^{( k , l )}$$

may be designed based on a mapping of bits to all available patterns of the vectors

$${I}_{fs}^{( k , l )} .$$

Then, the additional configuration signaling may be changed if information is to be embedded on the LFM signal rate domain or the modulation domain.

When not all LFM signals of the K possible LFM signals are used, i.e. fewer are used than the number available, a spacing, or sparsity, may be considered to exist between the LFM signals. When there is no constraint on a sparsity level of

$${I}_{fs }^{( k , l )} ,$$

the information bit mapping from

$${b}_{fs} \to {I}_{fs}^{( k , l )}$$

may be made a one-to-one mapping, in which for each selected FS value, the corresponding bit in b_{fs} may be chosen as 1. In this case, assuming FMCW waveform (ϑ^{(k,l)}=1) and focusing on a single symbol and BWP, the ISAC signal may be written as:

$$x ( t ) = {\sum }_{k = 0}^{K - 1} {b}_{k} {q}_{k} exp ( j 2 π ( {f}_{0} + k Δ f ) t + j π α {t}^{2} )$$

wherein

$$α = \frac{B}{T}$$

is fixed and the information is only conveyed through selection or modulation over the set of frequencies (f₀, f₁, . . . , f_{K-1})=f₀+kΔf, k=0, . . . , K−1. Selection is made through the binary indicators Iₖ=bₖ and modulation is applied through QAM symbols qₖ (if QAM embedding mode is active), otherwise qₖ=1.

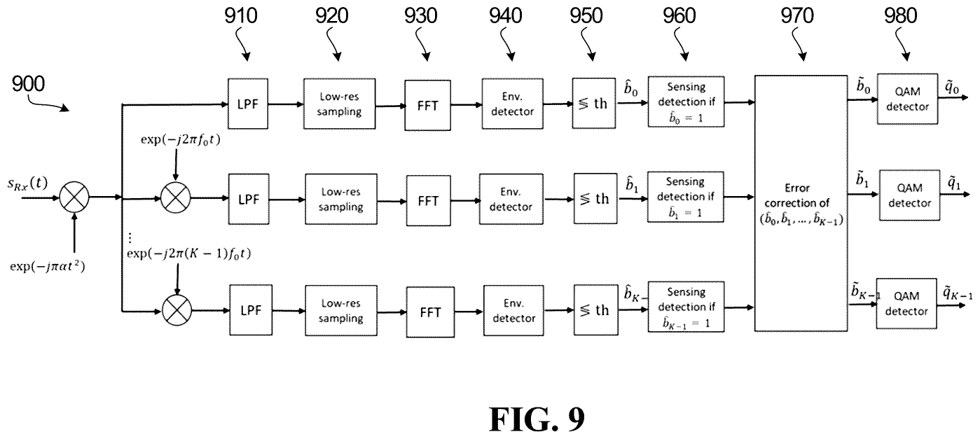

Benefits of this embodiment may include simpler signal transmission because only one LFM signal generation is needed and frequency shifts may be implemented by using mixers. In addition, this embodiment may use simpler detection as only one de-chirp circuit may be used. An example receiver structure 900 for this design that is capable of receiving, processing and demodulated a sensing signal is depicted in FIG. 9. The receiver structure 900 includes various components for performing various functions; each component may be implemented by a discrete device, a circuit in a larger device, a logical module, or any other suitable means to achieve its respective purpose. In the receiver structure of FIG. 9, a signal received at the receiver S_{Rx}(t) is mixed with exp(−jπαt²). The resulting signal is passed through to a low pass filter (LPF) 910 on a first branch and mixed with exp(−j2kπf₀t) on k=0 to K−1 on other branches. Each of the k branches includes a component 920 for performing low resolution sampling, a component 930 for performing a fast Fourier transform (FFT), a component 940 for performing envelope detection, a component 950 for performing thresholding, a component 960 for sensing signal detection for b₀=k, where k=0 to K−1. All the branches feed to a error correction component 970 and the error corrected signal [symbol] , k=0 to K−1 is provided to each of k branches having a quadrature amplitude modulation (QAM) detector 980 to provide a demodulated signal [symbol] .

The LPFs 910 in FIG. 9 eliminate potential aliasing at the output of the FFTs 930 caused by the low resolution sampling 920. This enables very low-resolution sampling, otherwise, a higher sampling frequency would be needed. In the case of using very low-resolution sampling, the number of branches may be reduced and all the bits may be processed together. The structure illustrated in FIG. 9 does not imply any sensing performance compromise. Another feature of the proposed scheme is introducing sensing-based error correction, e.g. removing falsely detected sensing signals by determining if a physical range detected using a sensing signal over a given branch (representing a particular frequency shift value) matches with the detected physical range of at least one other branch.

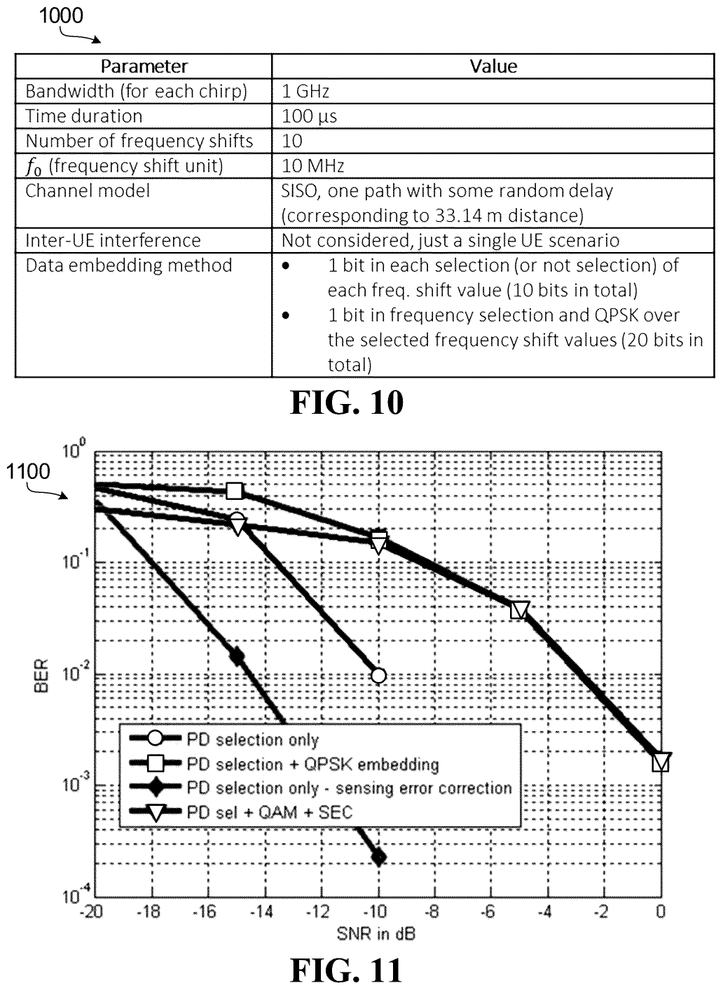

Computer simulations have been performed to observe communication performance of the proposed scheme, with the parameter value assumptions summarized in the table 1000 shown in FIG. 10. The parameter values include a LFM or chirp bandwidth, a LFM or chirp time duration, a number of frequency shifts, the initial frequency f0, a channel model, whether inter-UE interference is considered or not, and a data embedding method. The simulation was performed for the particular set of parameters indicated in FIG. 10, which results shown in FIG. 11, but it is to be understood that when implemented, methods generally described herein may be applied to situations with similar or different parameter values to those shown in FIG. 10.

FIG. 11 is a graphical plot 1100 illustrating simulation results that indicate how some of the embodiments disclosed herein are able to provide acceptable communication performance with little to no impact on the sensing performance. The graphical plot 1100 shows the Bit Error Rate (BER), on the vertical axis, for a range of values of signal-to-noise ratios (SNR) in units of dB, on the horizontal axis, for four different types of signals. The four types of signals involve pseudo-doppler (PD) or PD and modulation selection. A first signal is a signal for which only PD is selected. A second signal is a signal for which PD is selected and quadrature phase shift keying (QPSK) embedding. A third signal is a signal for which PD is selected and sensing error correction is used. A fourth signal is a signal for which PD is selected and quadrature amplitude modulation (QAM) embedding as well as sensing error correction. It is seen that the third signal has improved performance as compared to the first signal due to the use of the additional sensing error correction and the fourth signal has improved performance as compared to the second signal due to the use of the additional sensing error correction. The simulation results also show acceptable performance in terms of BER for data communication using various types of ISAC waveforms. Therefore, embodiments of the present disclosure provides several advantages which are difficult to avoid, except possibly at the expense of increasing complexity, latency, and power consumption, which are not desired. It also shows the benefit of sensing error correction, naturally available from the proposed framework.

As mentioned above, the number of frequency shifts may be configured for each sensing device by using the parameters f₀, K, and Δf. The number of frequency shifts may be selected based on one or more of: an amount of information to be embedded in terms of a number of bits; a maximum doppler value for the UE, which determines the minimum value for Δf; and a sensing device identifier, for example a UE ID. The sensing device identifier may be used for interference management and making sure the frequency shift values of different UEs do not collide). This is performed by providing the mapping between f₀ and

$${n}_{ID}^{SeRS}$$

as mentioned in the previous section.

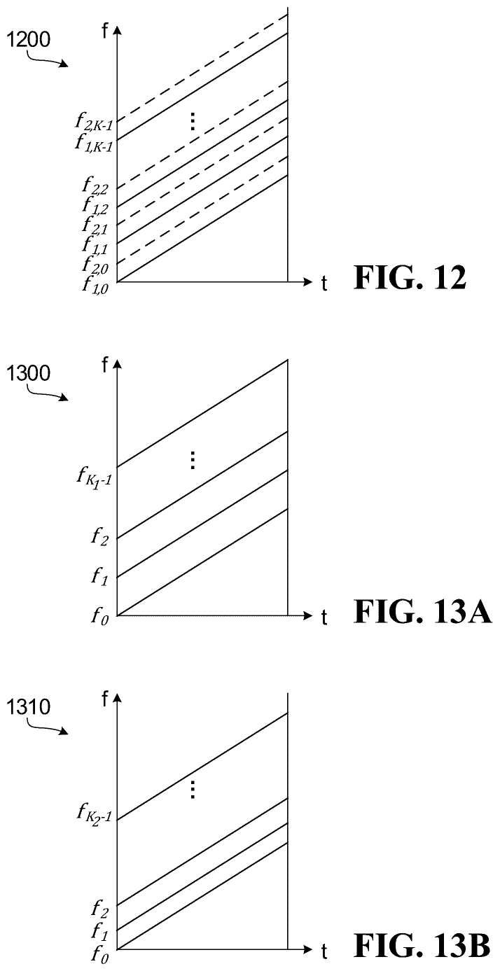

FIG. 12 shows an example of a time and frequency plot 1200 for 2K possible LFM signal waveforms. In FIG. 12, the set of 2K LFM waveforms, each having a linear frequency change over a given time slot, that are to be shared by multiple sensing device, in particular 2 UEs. The frequency shift values for a first UE (UE1) are denoted by f_{1,k}, k=0, K−1 and the frequency shift values for the second UE (UE2) are denoted by f_{2,k}, k=0, K−1. The number of LFM waveforms and the inter-frequency shift distance (Δf) is the same for both UEs, UE1 and UE 2, but the absolute values of the frequency shifts differ for the two UEs. It should be noted that not all of the LFM waveforms are necessarily used. As shown in FIG. 7, some of the LFM waveforms are not used to embed information in the sensing signal. This may be helpful as part of interference management when both UEs transmit their sensing signals simultaneously, so that the sensing signals do not perfectly overlap.

FIGS. 13A and 13B illustrate a second example that corresponds to a case wherein both the number of the frequency shifts K, in the plot 1300 shown in FIG. 13A and the number of the frequency shifts K₂ in the plot 1310 shown in in FIG. 13B and the inter-frequency shift distance (Δf) are different for two sets of LFM waveforms. Each set of LFM waveforms is for use by one of two UEs, UE1 and UE2. The scale on the frequency axis is the same for the plots 1300,1310 in FIG. 13A and FIG. 13B. As a result, it can be seen that the spacing of the frequency shifts are closer together in FIG. 13B than the spacing of the frequency shifts in FIG. 13A. By including more frequency shifts in a given bandwidth, more information may be embedded in the sensing signal. In addition, the inter-frequency shift distance (Δf) may be configured to be smaller for low mobility UEs, because there is less detection error due to Doppler. It should be noted that not all of the LFM waveforms in FIGS. 13A and 13B are necessarily used. As shown in FIG. 7, some of the LFM waveforms are not used to embed information in the sensing signal.

In some embodiments, there might be a constraint on a maximum number of simultaneously selected frequency shift values, which may be denoted as K*, i.e. the sensing device may be configured to select only up to a certain number of frequency shifts simultaneously from the entire set of available frequency shift values (K). The constraint on the sparsity level of

$${I}_{fs}^{( k , l )}$$

may be que to transmitter capability or receiver capability. The transmitter capability may be constrained, for example, due to a maximum tolerable peak-to-average power ratio (PAPR). The receiver capability may be constrained, for example, due to detection capability. The transmitter capability or the receiver capability may be signaled through a device capability report. In some embodiments, the amount of embedded information may be bounded in the form

$$R \leq {log}_{2} ( {\sum }_{k = 1}^{{K}^{*}} ( \begin{matrix}K \\ k\end{matrix} ) ) .$$

Based on the above disclosure of transmitter capability and receiver capability, when a node is configured to be a transmitter of the sensing signal, the node transmit sensing transmitter capability information and when a device is configured to be a receiver of a sensing signal, the node transmits feedback of the sensing receiver capability. In some embodiments, a node may be configured/instructed to feedback both transmitter and receiver capability in order for the network or for example, a sensing management function (SMF), for selection of proper nodes for a particular sensing task.

In some embodiments, the information is embedded in a selection pattern of the LFM waveforms. In some embodiments, the UE may be configured to select only K* chirps out of total of K chirps. In this case, the amount of embedded information may be bounded in the form

$$R \leq {log}_{2} ( ( \begin{matrix}K \\ {K}^{*}\end{matrix} ) ) .$$

In some embodiments, the information embedding is a combination of sparsity pattern selection and frequency shift selection among a sparse set of LFM waveforms.

An example will now be described that provides details of the configuration information and signaling, with an emphasis on the information embedding occurring on only the frequency shift domain. Because there are different configurations in terms of sensing transmitter nodes and sensing receiver nodes, the configuration information signaling may be from a network to a UE (downlink (DL), from the UE to the network (uplink (UL)) or from the UE to another UE (sidelink (SL)). In some embodiments, the network may send the configuration information to one or more UE even in the case of UL/SL sensing.

The network may receive a capability report from the device that may eventually transmit the sensing signal with the embedded information, such as a UE, related to information embedding on the sensing signal (information for the transmitter side and receiver side). The capability report may include information such as at least one of a PAPR constraint or a receiver decoding constraint. The PAPR constraint may be translated to a maximum number of simultaneously transmitted LFM waveforms (K*). In some embodiments, K* may be directly signaled. The receiver decoding constraint is a maximum number of blind detections for the LFM waveform with the same LFM waveform rate (denoted by

$${K}_{rx}^{*} ) .$$

In some embodiments, the receiver decoding constraint may further include at least one of an indication of a capability to detect multiple LFM waveform rates or an indication of detection of QAM symbols, in addition to the capability of LFM waveform index detection. The reporting format for the receiver detecting capability of multiple LFM waveform rates may be in the form of a binary indicator, when the binary indicator is set to “1”, this means the receiver is capable of detecting multiple LFM waveform rates, and another parameter, may define a number of simultaneous LFM rates the receiver can detect. The capability of QAM detection may be expressed as another parameter, which may also be a binary indicator. When the QAM detection binary indicator is set to “1” this means the receiver is capable of embedding QAM on top of the sensing signal.

In some embodiments, the capability report is sent by the device that may eventually transmit the sensing signal to other devices over the SL. In this case, the capability report may be broadcast to neighboring devices.

In some embodiments, the network shares the capability information of the device with other devices in the network. This may occur in a scenario that a group of sensing devices is formed by the network and the network may send the capability report of the devices in the group to the group through broadcast or groupcast signaling.

The network may transmit the configuration information related to the information embedding of the sensing signal (for example a sensing signal reference signal (SeRS)), in addition to the general configuration information related to the sensing signal, the general configuration information related to the information embedding of the sensing signal including bandwidth, symbol time duration, and waveform type indication. A waveform type indication may indicate FMCW or triangular, which may be indicated by the parameter 9 as described above.

The configuration information related to the information embedding of the sensing signal may include one or more of the following parameters. An indicator variable which indicates whether the sensing signal includes any data to be decoded (is it mode 1 or mode 2, 3, 4). A name for such an indicator variable may be SeRSdataEmbedding. A configuration parameter which indicates what mode of data embedding is used. An example of a name for such a configuration parameter may be SeRSdataEmbeddingMode. The mode being used may correspond to one of the different modes of data embedding, for example SeRSdataEmbeddingMode=0 identifies mode 1, i.e. no data embedding (default/fallback mode) and SeRSdataEmbeddingMode=1 identifies data embedding only on the frequency shift domain. This configuration is normally sent though L1 signaling (e.g. downlink control information (DCI)).

Depending on the value of the configuration parameter (SeRSdataEmbeddingMode) different configurations are possible. If SeRSdataEmbeddingMode=0, then the configuration parameters include only the parameters of the sensing signal including bandwidth B, time symbol duration T and the mapping function between UE ID, SeRS ID

$$( {n}_{ID}^{SeRS} ) ,$$

and the parameters of the chirp signal including f₀ and α. The details have been provided in the previous sections.

If SeRSdataEmbeddingMode=1, one or more of the following parameters may be included as part of configuration information for embedding the information: a number of potential frequency shift values (N); a number of information bits to be embedded (N_{bit}): a maximum number of active chirps (K*),

$${f}_{0}^{( k , l )}$$

described above; Δf^{(k,l)} described above; and a mapping between the bit sequence b_{fs} to

$${I}_{fs}^{( k , l )} .$$

In some embodiments, the information embedding is applied over a subset of the chirps. For example, assuming N total chirps with distinct frequency shift values (f₁, . . . , f_{N}), the information embedding may be applied on N_{mod}<N of these chirps. In this case, the configuration parameters signaling may include an indication of the frequency shift indices subset [symbol] _{mod}, | [symbol] _{mod}|=N_{mod} over which data embedding is applied. In some embodiments, [symbol] _{mod} includes the first N_{mod} chirps corresponding to (f₁, . . . , f_{mod}). In some embodiments, [symbol] _{mod} includes the last N_{mod} chirps corresponding to (f_{N-N}_{_{mod}}₊₁, . . . , f_{N}). In such cases, only the indication of SeRSdataEmbeddingIndexSet={First, Last} and N_{mod} may be included in the configuration signaling.

In some embodiments, the number of information bits to be embedded (N_{bit}) may be specified as the modulation order, which is 2^{N}^{_{bit}}.

The maximum number of active chirps (K*) may also be referred to as sparsity level. If this parameter is left empty, a default value for K* is K, indicating all frequency shifts are used and that there is no sparsity constraint.

With regard to the mapping between the bit sequence b_{fs} to

$${I}_{fs }^{( k , l )} ,$$

there are multiple embodiments for the mapping. In a first embodiment, when there is no sparsity constraint and N_{bit}=N, i.e. the number of bits is equal to the number of available frequency shift values, then

$${I}_{fs}^{( k , l )} = {b}_{fs} ,$$

wherein an input bit sequence of all zeros is not allowed. In a second embodiment, when there is a sparsity constraint specified, or N_{bit}<N, then a mapping of b_{fs} to

$${I}_{fs}^{( k , l )}$$

may be performed by:

$$1 ) Define {n}^{*} = {2}^{{N}_{bit}} . Obtain X such that {\sum }_{m = 1}^{X - 1} ( \begin{matrix}N \\ m\end{matrix} ) < {n}^{*} \leq {\sum }_{m = 1}^{X} ( \begin{matrix}N \\ m\end{matrix} ) .$$

2) In the following table, 1ₓ denotes a vector of size N with “1” at the location of x and “0” elsewhere in the vector.

| # | ${I}_{fs}^{( k , l )}$ |
|---|---|
| 1, 2, ... , N | 1ₙ, 1 ≤ n ≤ N |
| $N + 1 , … , ( \begin{matrix}N \\ 2\end{matrix} )$ | 1ₙ_{₁} + 1ₙ_{₂}, 1 ≤ n1 < n₂ ≤ N |
| ... | ... |
| $( \begin{matrix}N \\ X - 1\end{matrix} ) + 1 , … , ( \begin{matrix}N \\ X\end{matrix} )$ | 1ₙ_{₁} + 1ₙ_{₂} + ··· + 1ₙ_{_{X}}, 1 ≤ n₁ < n₂ < ... < n_{X} ≤ N |

3) Obtain d=bin2dec(b_{fs}), where bin2dec denotes a binary to decimal conversion operation. Then,

$${I}_{fs}^{( k , l )}$$

may be obtained from the vector in the second column of the table corresponding to the d-th row.

In some embodiments, when there is information embedded on the LFM rate (SeRSdataEmbeddingMode=2 or 3), then the information embedding may be performed in a similar manner as in the frequency shift domain information embedding. There may be constraints on the sparsity level of

$${I}_{α}^{( k , l )} .$$

The information bit mapping from

$${b}_{α} \to {I}_{α}^{( k , l )}$$

may be performed based on mapping of bits to all available sparsity patterns of the vectors

$${I}_{α}^{( k , l )} .$$

The constraint on the sparsity level of

$${I}_{α}^{( k , l )}$$

may be due to the transmitter capability, such as due to maximum tolerable PAPR, or the receiver capability, such as due to detection complexity. The transmitter and/or receiver capability may be signaled to the network through capability report signaling. In some embodiments, a sparsity level of 1 (meaning there is only one non-zero value in the entire vector) is desired for

$${I}_{α}^{( k , l )}$$

and hence, the information is embedded on the index of the LFM rate used for SeRS transmission. In some embodiments, when the chirp rate

$${α}_{i}^{( k , l )}$$

is obtained based on

$$\frac{B}{T} [ 1 + \frac{i {K}_{1}}{{K}_{2}} ] ,$$

there may be higher layer signaling for the integer values K₁ and K₂. In some embodiments, when the chirp rate

$${α}_{i}^{( k , l )}$$

is obtained based on

$$\frac{B}{T} [ 1 + \frac{i {K}_{1}}{{K}_{2}} ] ,$$

codebook parameters for

$${I}_{α}^{( k , l )}$$

may include a starting index or i denoted by i₀, Δᵢ, a distance between adjacent i values and M, which is a total number of potential α values.

In some embodiments, when the information is embedded on the modulation domain, there may be additional signaling including a modulation constellation size (for example 2-point, 4-point, 16-point, etc.) and a constellation type parameter (for example QAM, phase amplitude modulation (PAM), etc.) denoted by relevant parameters. For example, a constellation size parameter may be identified as SeRSConstSize and a constellation type parameter may be identified as SeRSConstType. In some embodiments, the information embedding on the modulation domain is applied over a subset of the chirps. For example, assuming N total chirps with distinct frequency shift values (f₁, . . . , f_{N}), the modulation domain information embedding may be applied on N_{mod}<N of these chirps. In this case, the configuration parameters signaling may include an indication of the frequency shift indices subset [symbol] _{mod}, | [symbol] _{mod}|=N_{mod} over which modulation domain data embedding is applied. In some embodiments, [symbol] _{mod} includes the first N_{mod} chirps corresponding to (f₁, . . . , f_{mod}). In some embodiments, [symbol] _{mod} includes the last N_{mod} chirps corresponding to (f_{N-N}_{_{mod}}₊₁, . . . , f_{N}). In such cases, only the indication of SeRSmodIndexSet={First, Last} and N_{mod} may be included in the configuration signaling.

Configuration parameters identified above may be signaled through layer 1 (L1 or PHY) signaling or higher layer signaling such as RRC and/or MAC-CE.

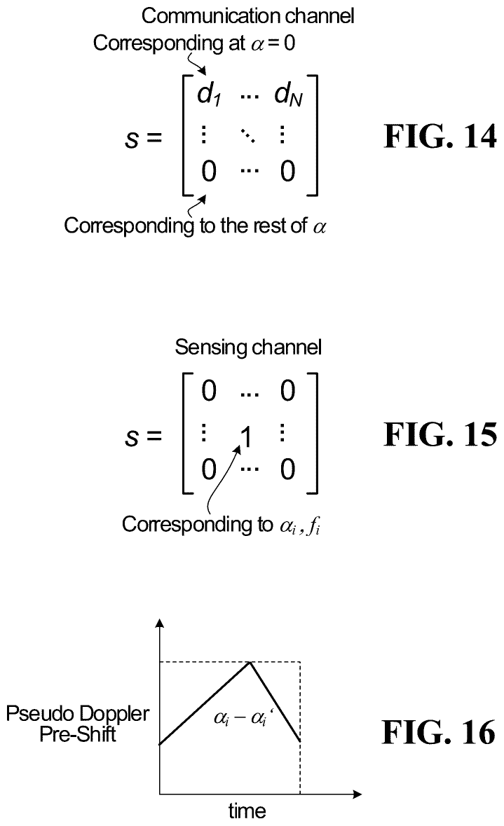

Some embodiments of the disclosure provide solutions for multiplexing of sensing and communication signals. In some embodiments, LFM slope domain may be used to define communication and sensing channels. In a particular example, when α=0, there is no LFM slope and so the channel corresponds to a communication channel. Considering the ISAC matrix shown in FIG. 7, when α=0, all rows have zero elements except for the row corresponding to α=0. This row is equal to the QAM vector d=(d₁, . . . , d_{N}), which is basically a fall-back to an OFDM waveform. This matrix S is shown in FIG. 14. If other rows of matrix S contain the QAM data vector, the waveform corresponds to a Fractional Fourier transform (FrFT) waveform.

In another particular example, when α≠0, the non-zero value of the LFM slope and so the channel corresponds to a sensing channel. This corresponds to an ultra-sparse ISAC matrix in which only one element of the matrix is non-zero (corresponding to one LFM slope and one pseudo-Doppler pre-shift) and the rest are zero. An example matrix S is shown in FIG. 15. In the case of the sensing channel, the LFM slope may be defined as

$${α}_{i} = ( {α}_{i} , - {{α}_{i}}^{′} ) ,$$

wherein

$${α}_{i}^{{′}^{}}$$

is related to αᵢ through

$$\frac{1}{{{α}_{i}}^{′}} = \frac{T}{B} - \frac{1}{{α}_{i}} ,$$

where T denotes a sensing symbol time and B is the LFM waveform bandwidth. This is related to a triangular LFM waveform as shown in the graphical plot over time and frequency in FIG. 16.

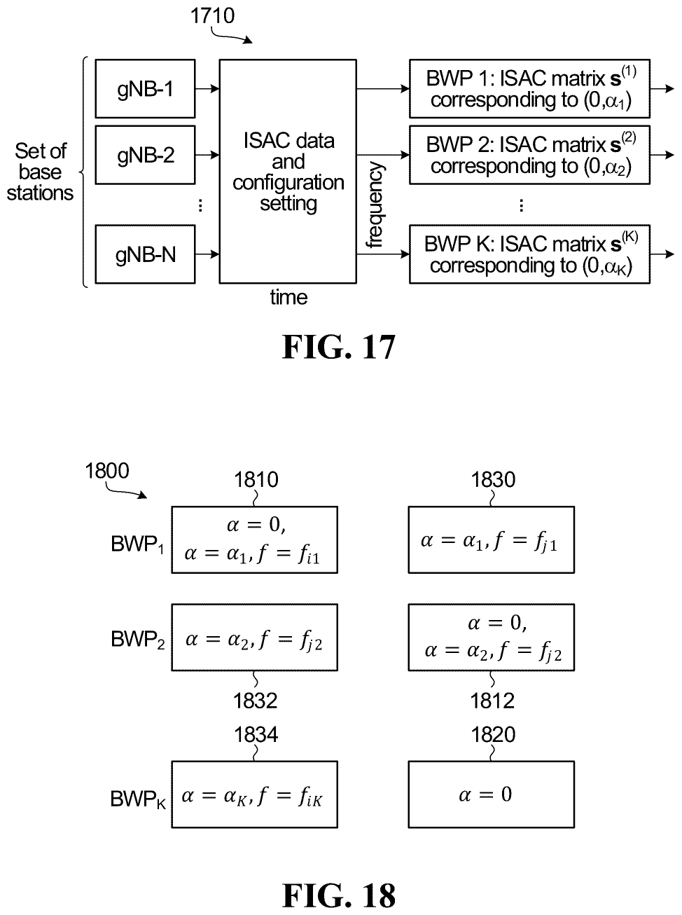

In some embodiments, the ISAC matrix for each sub-band or BWP for each network side device has a maximum of two non-zero rows. FIG. 17 illustrates, as an input to ISAC configuration setting 1710 information, a set of N base stations that may provide ISAC configuration 1710 information to multiple devices that will transmit sensing information, that enables ISAC matrices for each sub-band or BWP. A first non-zero row corresponds to potential communication data transmission (corresponding to α=0). A second non-zero row corresponds to the sensing channel with LFM waveform slope αₖ, k denoting the sub-band index.

The rationale for this design is that a device receiving the sensing signal needs to only adjust for one value of α. In some embodiments, the network-side device, such as a base station, may be separated in the frequency shift domain. For this purpose, a mapping function may be defined between the network-side device ID and the frequency shift vector (fᵢ₁, fᵢ₂, . . . , f_{iK}). In some embodiments, the network-side device, may be separated in the pseudo-Doppler domain. For this purpose, a mapping function may be defined between the network-side device ID and the pseudo-Doppler vector.

An example of a mapping function 1800 is shown in FIG. 18, wherein the boxes 1810 and 1812 in mapping function 1800 show the BWPs assigned for integrated communication and sensing (ISAC) with a first non-zero row corresponding to potential communication data transmission (α=0) and a second non-zero row corresponding to the sensing channel with LFM waveform slope αₖ, k denoting the sub-band index, box 1820 show the BWP assigned for communication only with α=0, and boxes 1830, 1832 and 1834 show the BWPs assigned for sensing only with LFM waveform slope αₖ, k denoting the sub-band index. The ISAC code for each network-side device may be defined per spatial domain element. This may include defining analog or digital beam and polarization domain.

In some embodiments, devices performing sensing may be configured to have two sets of ISAC codebooks over the configured or assigned BWPs. In some embodiments that include SL transmission, similar to DL, the LFM slopes may be limited to (0, αₖ) over BWP k (to minimize the receiver complexity). In some embodiments that include UL transmission, where the receiver complexity is not an issue, the ISAC codebook may not be constrained.

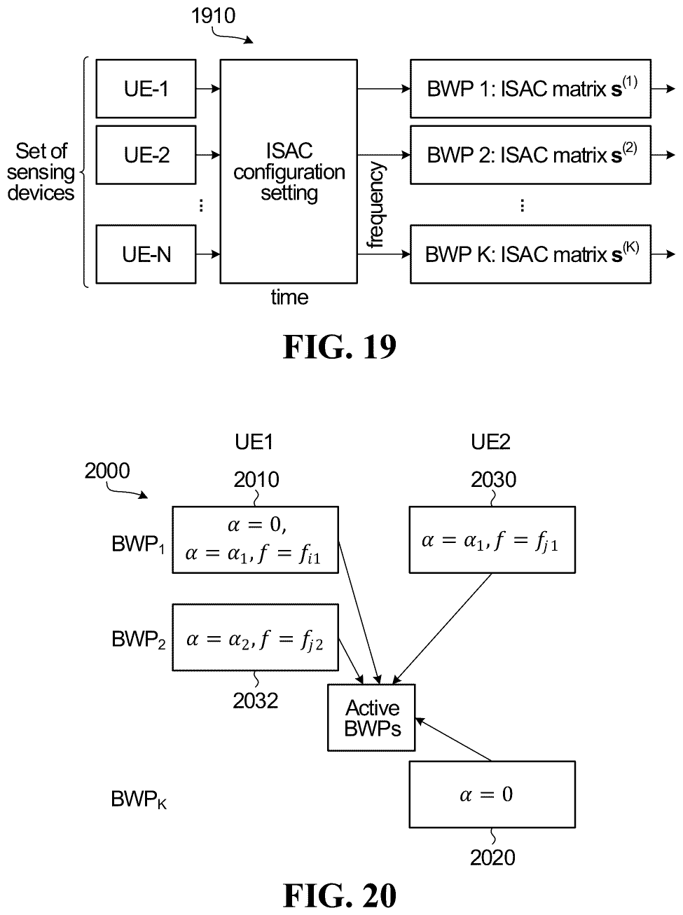

A general framework is shown in FIG. 19. FIG. 19 illustrates, as an input to ISAC configuration setting 1910 information, a set of N sensing devices that may provide ISAC configuration 1910 information that enables ISAC matrices for each sub-band or BWP. In the case of UL, a mapping function may be defined between the (αᵢₖ, fᵢₖ) for sensing device i and over BWP k and the sensing device id. In the case of SL, a mapping function can be defined between the index of fᵢₖ for sensing device i and over BWP k and the sensing device id. An example is shown in FIG. 20, wherein the box 2010 shows the active BWP (BWP₁) assigned for ISAC for UE1, box 2020 shows the active BWP (BWP_{K}) assigned for communication only for UE2, and boxes 2030 and 2032 show the active BWPs assigned for sensing only (BMP₁ for UE2 and BWP₂ for UE1). In the case of both SL and UL, the indices of active BWPs may be configured/assigned to the UE. Similar to DL, an ISAC codebook for each UE may be defined per spatial domain element, such as analog or digital beam and polarization domain.

In some embodiments, node ID or signature ID and data may be embedded on the sensing signal. There are multiple ways in which this may be performed. Three particular examples will be described below.

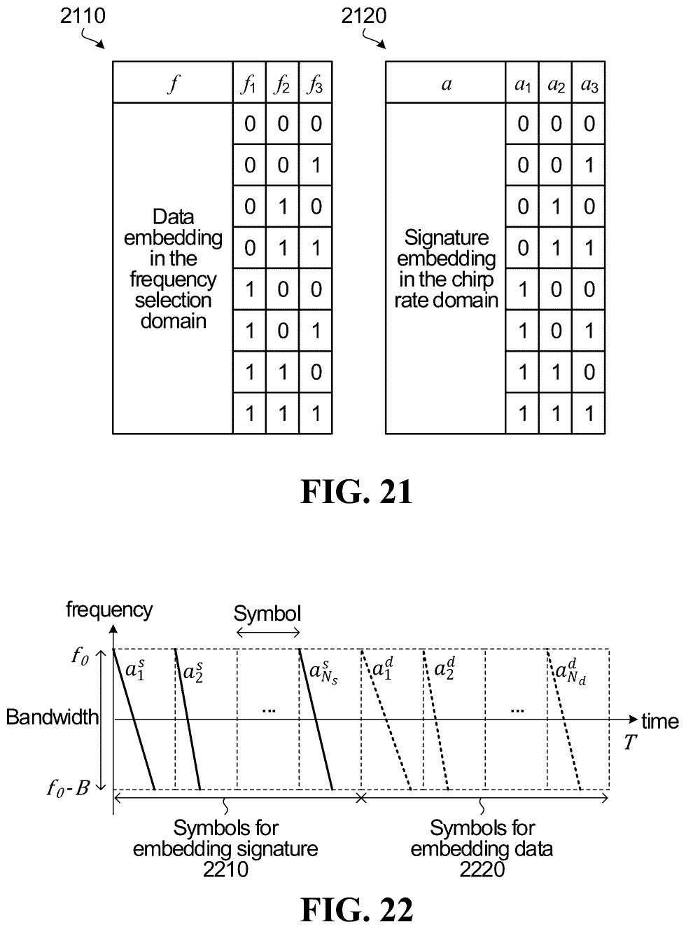

In a first example, data may be carried in non-zero indices of the rows of the of the ISAC matrix S (i.e. frequency shift domain) and carrying signature IDs in the non-zero indices of the columns of the ISAC matrix S (i.e. LFM rate domain). Examples of two look-up tables containing sets of bits that may be used to correspond to either data or signature ID are shown in FIG. 21. In a first look-up table 2110, three bits are used for data embedding in the frequency selection domain. In a second look-up table 2120, three bits are used for signature ID embedding in the LFM rate domain. While the look-up tables are shown to have three bits each, it is understood that the number of bits may be less than or greater than three bits. Furthermore, it is to be understood that if both types of lookup table were used, they would not have to have the same number of bits.

In a second example, data may be embedded in the frequency shift domain and signature ID may be embedded in a LFM rate hopping pattern. Alternatively, data may be embedded in a frequency shift hopping pattern and signature ID may be embedded in LFM rate domain. Applying a hopping pattern allows content of at least one of the rows or the columns of ISAC matrix S to vary across at least one of different BWPs or different time symbols. In some embodiments, size of the data being embedded may be enlarged by hopping over the BWP (independent information per BWP), over time, or over both BWP and time.

In a third example, signature ID and data may be separated or multiplexed in at least one of time domain or frequency domain. FIG. 22 illustrates, for a single BWP having a bandwidth B, multiple sensing symbols. A first set of sensing symbols

$$( {α}_{1}^{s} , {α}_{2}^{s} , … , {α}_{{N}_{s}}^{s} )$$

2210 carry a signature ID embedded in at least of one of LFM rate or frequency shift on the symbols in the sensing signal. A second set of sensing symbols

$$( {α}_{1}^{d} , {α}_{2}^{d} , … , {α}_{{N}_{d}}^{d} )$$

2220 carry data embedded in at least of one of LFM rate or frequency shift on the symbols in the sensing signal. While the sets of sensing symbols 2210 and 2220 are shown in an order of signature ID embedded in the first set of sensing symbols and data embedded in the second set of sensing symbols, it should be understood that this order may be reversed.

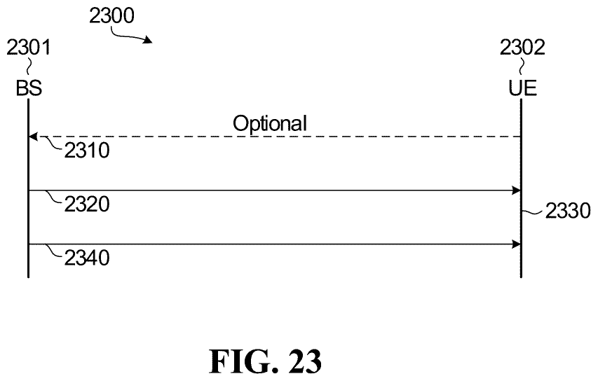

FIG. 23 is a signal flow diagram 2300 for signaling between a network-side device, such as a base station 2301 and a sensing device, such as a UE 2302 that is configured to send a sensing signal with additional information embedded on the sensing signal.

Step 2310 is an optional step. The base station 2301 may receive UE capability information from the UE 2302. The capability information may include information such as at least one of a PAPR constraint or a receiver decoding constraint. The PAPR constraint may be translated to a maximum number of simultaneously transmitted LFM waveforms (K*). In some embodiments, K* may be directly signaled. The receiver decoding constraint is a maximum number of blind detections for the LFM waveform with the same LFM waveform rate (denoted by

$${K}_{r x}^{*} ) .$$

At step 2320, the base station 2301 sends configuration information to the UE 2302 pertaining to the UE 2302 generating a sensing signal. The UE 2303 may use the configuration information to generate a sensing signal that is configured to convey information.

In some embodiments, the configuration information includes an information mapping configuration. In some embodiments, the information mapping configuration information is comprised of only selection mapping or selection and modulation based mapping. Only selection mapping corresponds to selecting one or more parameters as part of the mapping of information on to the sensing signal. Selection and modulation based mapping corresponds to selecting one or more parameters as part of the mapping as well as modulation of the sensing signal.

In some embodiments, the only selection information mapping configuration is comprised of only frequency shift mapping.

In some embodiments, the frequency shift-only mapping is a combination of sparsity pattern selection and frequency shift selection among the plurality of LFM signals.

In some embodiments, the information conveyed by the set of information bits is embedded in the sensing signal by embedding the information in at least one of: the frequency shift domain; the frequency shift domain and the modulation domain; or the frequency shift domain and the frequency slope domain.

In some embodiments, the plurality of LFM signals all have a same frequency slope.

In some embodiments, the starting frequency of an LFM signal of a given carrier index n in the plurality of LFM signals is expressed as fₙ=f₀+nΔf, n=0, . . . , N−1, wherein f₀ is a first frequency shift value; Δf is a LFM carrier spacing; and N is a total number of LFM carrier indices.

In some embodiments, the configuration information includes at least one of: a first frequency shift value f₀; a LFM carrier spacing Δf; a total number of LFM carrier indices N; or a maximum allowable number K* of LFM signals in the subset of the plurality of LFM signals.

In some embodiments, the information conveyed by the set of information bits comprises at least one of: node identification; node location information; sensing type; sensing session identification; or system information (SI).

At step 2330, the UE 2303 generates the sensing signal by selecting a subset of a plurality of linear frequency modulated (LFM) signals at least in part based on the configuration information received in step 2320. The subset of the plurality of LFM signals are selected for the sensing signal from the plurality of LFM signals based on a mapping of a set of information bits to at least one of selection of at least one LFM signal of the plurality of LFM signals or modulation of the plurality of LFM signals. The set of information bits is used to convey the information in the sensing signal.

At step 2340, the UE transmits the sensing signal with the additional information embedded in the sensing signal.

Examples of devices (e.g., ED or UE and TRP or network device) to perform the various methods described herein are also disclosed. For example, a (first) device may include a memory to store processor-executable instructions, and a processor to execute the processor-executable instructions. When the processor executes the processor-executable instructions, the processor may be caused to perform the method steps of one or more of the devices as described herein, e.g., in relation to figures described above. For example, the processor may cause the device to communicate over an air interface in a mode of operation by implementing operations consistent with that mode of operation, e.g. performing necessary measurements and generating content from those measurements, as configured for the mode of operation, preparing uplink transmissions and processing downlink transmissions, e.g. encoding, decoding, etc., and configuring and/or instructing transmission/reception on RF chain(s) and antenna(s).

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

It should be appreciated that one or more steps of the embodiment methods provided herein may be performed by corresponding units or modules. For example, a signal may be transmitted by a transmitting unit or a transmitting module. A signal may be received by a receiving unit or a receiving module. A signal may be processed by a processing unit or a processing module. The respective units/modules may be hardware, software, or a combination thereof. For instance, one or more of the units/modules may be an integrated circuit, such as field programmable gate arrays (FPGAs) or application-specific integrated circuits (ASICs). It will be appreciated that where the modules are software, they may be retrieved by a processor, in whole or part as needed, individually or together for processing, in single or multiple instances as required, and that the modules themselves may include instructions for further deployment and instantiation.

Although a combination of features is shown in the illustrated embodiments, not all of them need to be combined to realize the benefits of various embodiments of this disclosure. In other words, a device, apparatus, system or method designed according to an embodiment of this disclosure will not necessarily include all of the features shown in any one of the figures or all of the portions schematically shown in the figures. Moreover, selected features of one example embodiment may be combined with selected features of other example embodiments.

While this disclosure has been described with reference to illustrative embodiments, this description is not intended to be construed in a limiting sense. Various modifications and combinations of the illustrative embodiments, as well as other embodiments of the disclosure, will be apparent to persons skilled in the art upon reference to the description. It is therefore intended that the appended claims encompass any such modifications or embodiments.

What is claimed is:

1. A method comprising:
receiving configuration information pertaining to generating a sensing signal, the sensing signal being configured to convey information;
generating the sensing signal by selecting a subset of a plurality of linear frequency modulated (LFM) signals based on the configuration information, wherein the subset of the plurality of LFM signals are selected for the sensing signal from the plurality of LFM signals based on a mapping of a set of information bits to at least one of:
selection of at least one LFM signal of the plurality of LFM signals; or
modulation of at least one of the plurality of LFM signals; and
wherein the set of information bits is used to convey the information in the sensing signal; and
transmitting the sensing signal.

2. The method of claim 1, wherein the configuration information comprises an information mapping configuration comprising a selection mapping, wherein the selection mapping corresponds to selecting one or more parameters as part of the mapping of information on to the sensing signal.

3. The method of claim 1, wherein the configuration information comprises an information mapping configuration comprising a selection and modulation based mapping, and the selection and modulation based mapping corresponds to selecting one or more parameters as part of the mapping and as part of modulation of the sensing signal.

4. The method of claim 1, wherein the information conveyed by the set of information bits is embedded in the sensing signal by embedding the information in at least one of:
a frequency shift domain;
the frequency shift domain and a modulation domain; or
the frequency shift domain and a frequency slope domain.

5. The method of claim 1, wherein the starting frequency of an LFM signal of a given carrier index n in the plurality of LFM signals is expressed as fₙ=f₀+nΔf, n=0, . . . , N−1, wherein f₀ is a first frequency shift value; Δf is a LFM carrier spacing; and N is a total number of LFM carrier indices.

6. The method of claim 1, wherein the configuration information includes at least one of:
a first frequency shift value f₀;
a LFM carrier spacing Δf;
a total number of LFM carrier indices N; or
a maximum allowable number K* of LFM signals in the subset of the plurality of LFM signals.

7. The method of claim 1, wherein the information conveyed by the set of information bits comprises at least one of:
node identification;
node location information;
sensing type;
sensing session identification; or
system information (SI).

8. An apparatus comprising:
at least one processor; and
a memory coupled to the at least one processor, the memory including instructions that, when executed by the at least one processor, cause the apparatus to:
receive configuration information pertaining to generating a sensing signal, the sensing signal being configured to convey information;
generate the sensing signal by selecting a subset of a plurality of linear frequency modulated (LFM) signals based on the configuration information, wherein the subset of the plurality of LFM signals are selected for the sensing signal from the plurality of LFM signals based on a mapping of a set of information bits to at least one of:
selection of at least one LFM signal of the plurality of LFM signals; or
modulation of at least one of the plurality of LFM signals; and
wherein the set of information bits is used to convey the information in the sensing signal; and
transmit the sensing signal.

9. The apparatus of claim 8, wherein the configuration information comprises an information mapping configuration comprising a selection mapping, wherein the selection mapping corresponds to selecting one or more parameters as part of the mapping of information on to the sensing signal.

10. The apparatus of claim 8, wherein the configuration information comprises an information mapping configuration comprising a selection and modulation based mapping, and wherein the selection and modulation based mapping corresponds to selecting one or more parameters as part of the mapping and as part of modulation of the sensing signal.

11. The apparatus of claim 8, wherein the information conveyed by the set of information bits is embedded in the sensing signal by embedding the information in at least one of:
a frequency shift domain;
the frequency shift domain and a modulation domain; or
the frequency shift domain and a frequency slope domain.

12. The apparatus of claim 8, wherein the starting frequency of an LFM signal of a given carrier index n in the plurality of LFM signals is expressed as fₙ=f₀+nΔf, n=0, . . . , N−1, wherein f₀ is a first frequency shift value; Δf is a LFM carrier spacing; and N is a total number of LFM carrier indices.

13. The apparatus of claim 8, wherein the configuration information includes at least one of:
a first frequency shift value f₀;
a LFM carrier spacing Δf;
a total number of LFM carrier indices N; or
a maximum allowable number K* of LFM signals in the subset of the plurality of LFM signals.

14. The apparatus of claim 8, wherein the information conveyed by the set of information bits comprises at least one of:
node identification;
node location information;
sensing type;
sensing session identification; or
system information (SI).

15. A method comprising:
transmitting configuration information pertaining to a device generating a sensing signal, the sensing signal configured to convey information by the device and the sensing signal comprising a subset of a plurality of linear frequency modulated (LFM) signals based on the configuration information, wherein the subset of the plurality of LFM signals are selected for the sensing signal from the plurality of LFM signals based on a mapping of a set of information bits to at least one of:
selection of at least one LFM signal of the plurality of LFM signals; or
modulation of at least one of the plurality of LFM signals; and
wherein the set of information bits is used to convey the information in the sensing signal.

16. The method of claim 15, wherein the configuration information comprises an information mapping configuration comprising a selection mapping, wherein the selection mapping corresponds to selecting one or more parameters as part of the mapping of information on to the sensing signal.

17. The method of claim 15, wherein the configuration information comprises an information mapping configuration comprising a selection and modulation based mapping, and the selection and modulation based mapping corresponds to selecting one or more parameters as part of the mapping and part of modulation of the sensing signal.

18. The method of claim 15, wherein the information conveyed by the set of information bits is embedded in the sensing signal by embedding the information in at least one of:
a frequency shift domain;
the frequency shift domain and a modulation domain; or
the frequency shift domain and a frequency slope domain.

19. The method of claim 15, wherein the starting frequency of an LFM signal of a given carrier index n in the plurality of LFM signals is expressed as fₙ=f₀+nΔf, n=0, . . . , N−1, wherein f₀ is a first frequency shift value; Δf is a LFM carrier spacing; and N is a total number of LFM carrier indices.

20. The method of claim 15, wherein the configuration information includes at least one of:
a first frequency shift value f₀;
a LFM carrier spacing Δf;
a total number of LFM carrier indices N; and
a maximum allowable number K* of LFM signals in the subset of the plurality of LFM signals.
